(19) United States
(12) Patent Application Publication
(10) Pub. No.: US 2023/0396184 A1
(43) Pub. Date: Dec. 7, 2023

(54) POWER CONVERTING APPARATUS, THREE-LEVEL INVERTER, CONTROL METHOD OF POWER CONVERTING APPARATUS, AND CONTROL METHOD OF THREE-LEVEL INVERTER

(71) Applicant: Yaskawa America, Inc., Waukegan, IL (US)

(72) Inventors: Taisuke KATAYAMA, Kitakyushu-shi (JP); Eiji WATANABE, Kitakyushu-shi (JP)

(73) Assignee: Yaskawa America, Inc., Waukegan, IL (US)

(21) Appl. No.: 18/451,867

(22) Filed: Aug. 18, 2023

Related U.S. Application Data
(63) Continuation of application No. PCT/JP2022/006680, filed on Feb. 18, 2022.

(51) Int. Cl. H02M 7/483; H02M 1/088; H02M 1/00; H02M 1/32

(52) U.S. Cl. CPC H02M 7/483; H02M 1/327; H02M 1/0025; H02M 1/088

(57) ABSTRACT

A power converting apparatus includes one or more series multiplex power converter each including single-phase power converting cells. Outputs of the single-phase power converting cells are connected in series. Each of the single-phase power converting cells has switching elements and is configured to output an output voltage by switching the switching elements in accordance with the drive signal. The control circuitry is configured to output the drive signal to the single-phase power converting cells such that, during a halt period in which the switching elements of at least one of the single-phase power converting cells do not perform switching at a short time interval shorter than a predetermined time interval to output the output voltages, the switching elements of a remainder of the single-phase power converting cells performs switching at the short time interval to output the output voltages.

### CROSS-REFERENCE TO RELATED APPLICATIONS

The present application is a continuation application of International Application No. PCT/JP2022/006680, filed Feb. 18, 2022, which claims priority under 35 U. S. C. § 119 to U.S. Provisional Patent Application No. 63/151,350, filed Feb. 19, 2021. The contents of these applications are incorporated herein by reference in their entirety.

### BACKGROUND

### Field of the Invention

The present invention relates to a power converting apparatus, a three-level inverter, a control method of a power converting apparatus, and a control method of a three-level inverter.

### Background Art

In a power converting apparatus such as a conventional converter, there is known a technique for generating a variable frequency power output using a PWM (Pulse Width Modulation) signal and a switching device such as an IGBT (Insulated Gata Bipolar Transistor) controlled by the PWM signal (for example, refer to Japanese Patent Application Laid-Open No. 2015-211595 and U.S. Pat. No. 9,906,168).

### SUMMARY

According to one aspect of the present disclosure, a power converting apparatus includes control circuitry configured to output a drive signal, and one or more series multiplex power converter each including a plurality of single-phase power converting cells. Outputs of the plurality of single-phase power converting cells being connected to each other in series. Each of the plurality of single-phase power converting cells has a plurality of switching elements and is configured to output an output voltage by switching the plurality of switching elements in accordance with the drive signal. The control circuitry is configured to output the drive signal respectively to the plurality of single-phase power converting cells such that, during a halt period in which the plurality of switching elements of at least one of the plurality of single-phase power converting cells do not perform switching at a short time interval which is shorter than a predetermined time interval to output the output voltages, the plurality of switching elements of a remainder of the plurality of single-phase power converting cells performs switching at the short time interval to output the output voltages.

According to another aspect of the present disclosure, a three-level inverter includes a plurality of switching elements, control circuitry configured to output drive signals, and a DC power source configured to output three voltage levels. The plurality of switching elements are connected to the DC power source and configured to output a plurality of phase voltages corresponding to a plurality of phases by switching the switching elements. The control circuitry includes a command generator configured to generate phase voltage commands corresponding to the plurality of phase voltages respectively and adjusted phase voltage commands to be compared with carrier signals; a PWM signal generator configured to generate the drive signals based on the adjusted phase voltage commands and the carrier signals; and a phase selector configured to sequentially select a selected phase among the plurality of phrases such that an absolute value of a phase voltage command corresponding to the selected phase is maximum among absolute values of phase voltage commands corresponding to the plurality of phases, respectively. The command generator sets a period during which the selected phase is selected as a halt period and generates the adjusted phase voltage commands such that the phase voltage command corresponding to the selected phase is set to a value corresponding to an intermediate voltage level among the three voltage levels.

According to the other aspect of the present disclosure, a control method of a power converting apparatus includes providing one or more series multiplex power converters each having a plurality of single-phase power converting cells, each of the plurality of single-phase power converting cells having a plurality of switching elements, outputs of the plurality of single-phase power converting cells being connected to each other in series; outputting a drive signal by control circuitry and supplying the drive signal to each of the plurality of switching elements; outputting the drive signal in a halt period to at least one of the plurality of single-phase power converting cells such that the plurality of the switching elements of the at least one of the plurality of single-phase power converting cells do not perform switching at a short time interval shorter than a predetermined time interval to output the output voltages; and outputting the drive signal in the halt period to a reminder of the plurality of single-phase power converting cells such that the plurality of switching elements of the remainder of the plurality of single-phase power converting cells perform the switching at the short time interval to output the output voltages.

According to further aspect of the present disclosure, a control method of a three-level inverter includes providing the three-level inverter including a DC power source to output three voltage levels, a plurality of switching elements connected to the DC power source, and control circuitry to output drive signals; switching each of the plurality of switching elements to output a plurality of phase voltages corresponding to a plurality of phases; generating phase voltage commands corresponding to each of the plurality of phase voltages and adjusted phase voltage commands to be compared with carrier signals; generating the drive signals based on the adjusted phase voltage commands and the carrier signals; sequentially selecting a selected phase among the plurality of phrases such that an absolute value of a phase voltage command corresponding to the selected phase is maximum among absolute values of phase voltage commands corresponding to the plurality of phases, respectively; and generating the adjusted phase voltage commands during a halt period in which the selected phase is selected such that the phase voltage command corresponding to the selected phase is set to a value corresponding to an intermediate voltage level among the three voltage.

### DESCRIPTION OF THE DRAWINGS

Many of the advantages of a more complete understanding of the present invention will become readily apparent by reference to the following detailed description, particularly when considered in conjunction with the accompanying drawings.

FIG. 1 is a schematic diagram illustrating an overall configuration of a power converting apparatus.

FIG. 2A is a schematic diagram illustrating a first unit configuration of the power converting apparatus.

FIG. 2B is a schematic diagram illustrating a second unit configuration of the power converting apparatus.

FIG. 2C-1 is a schematic diagram illustrating a third unit configuration of the power converting apparatus.

FIG. 2C-2 is a schematic diagram illustrating a detailed configuration of the power converting apparatus of FIG. 2C-1.

FIG. 2D is a schematic diagram illustrating a fourth unit configuration of the power converting apparatus.

FIG. 2E is a schematic diagram illustrating a fifth unit configuration of the power converting apparatus.

FIG. 2F is a schematic diagram illustrating a sixth unit configuration of the power converting apparatus.

FIG. 3A is a schematic diagram illustrating an example of a single-phase power converting cell of the power converting apparatus.

FIG. 3B is a schematic diagram illustrating another example of the single-phase power converting cell of the power converting apparatus.

FIG. 3C is a schematic diagram illustrating further another example of the single-phase power converting cell of the power converting apparatus.

FIG. 3D is a schematic diagram illustrating further another example of the single-phase power converting cell of the power converting apparatus.

FIG. 4A-1 is a graph showing output waveforms from the single-phase power converting cell of the first and second unit configurations of the power converting apparatus illustrated in FIGS. 2A and 2B.

FIG. 4A-2 is a graph obtained by labeling the graph shown in FIG. 4A-1 with a halt period and a PWM outputting period.

FIG. 4A-3 is a table illustrating switching and halt period of the respective single-phase power converting cell with respect to a voltage range of a command voltage when outputting the phase voltage of the graph illustrated in FIG. 4A-1.

FIG. 4A-4 is a diagram illustrating a correspondence relationship between an example of a command voltage and each voltage range of FIG. 4A-3.

FIG. 4A-5 is a table showing another example of the switching and halt period of each of the single-phase power converting cell with respect to the voltage range of the command voltage when outputting the phase voltage of the graph shown in FIG. 4A-1.

FIG. 4B-1 is a graph showing another output waveform from each of the single-phase power converting cell of the first and second unit configurations of the power converting apparatus illustrated in FIGS. 2A and 2B.

FIG. 4B-2 is a graph obtained by labeling the graph shown in FIG. 4B-1 with a halt period.

FIG. 4B-3 is a table showing switching and halt period of the respective single-phase power converting cell with respect to the voltage range of the command voltage when outputting the phase voltage of the graph shown in FIG. 4B-1.

FIG. 4C-1 is a graph showing further another output waveform from each of the single-phase power converting cell of the first and second unit configurations of the power converting apparatus illustrated in FIG. 2A and FIG. 2B.

FIG. 4C-2 is a graph obtained by labeling the graph shown in FIG. 4C-1 with a halt period.

FIG. 4C-3 is a table showing switching and halt period of the respective single-phase power converting cell with respect to the voltage range of the command voltage when outputting the phase voltages of the graphs shown in FIGS. 4C-1 and 4D-1.

FIG. 4C-4 is a table showing another example of the switching and halt period of each of the single-phase power converting cell with respect to the voltage range of the command voltage when outputting the phase voltage of the graph shown in FIGS. 4C-1 and 4D-1.

FIG. 4D-1 is a graph showing still another output waveform from each of the single-phase power converting cell of the first and second unit configurations of the power converting apparatus illustrated in FIGS. 2A and 2B.

FIG. 4D-2 is a graph obtained by labeling the graph shown in FIG. 4D-1 with a halt period.

FIG. 4E-1 is a graph showing output waveforms from the third unit configuration of the power converting apparatus illustrated in FIG. 2C-1 and FIG. 2C-2.

FIG. 4E-2 is a graph obtained by labeling the graph shown in FIG. 4E-1 with a halt period.

FIG. 4E-3 is a table showing switching and halt period of the respective single-phase power converting cell with respect to the voltage range of the command voltage when outputting the phase voltages of the graphs shown in FIGS. 4E-1 and 4F-1.

FIG. 4F-1 is a graph showing another output waveform for the third unit configuration of the power converting apparatus illustrated in FIGS. 2C-1 and 2C-2.

FIG. 4F-2 is a graph obtained by labeling the graph shown in FIG. 4F-1 with a halt period.

FIG. 4G-1 is a table showing switching and halt period of the respective single-phase power converting cell with respect to the voltage range of the command voltage when outputting the phase voltage in the fourth unit configuration of the power converting apparatus.

FIG. 4H-1 is a graph showing an output waveform equivalent to the signal of the graph illustrated in FIG. 3D-1 outputted from the matrix converter illustrated in FIG. 4A-1 to which an AC voltage is applied.

FIG. 4I-1 is a graph showing an output waveform equivalent to the signal of the graph illustrated in FIG. 3D-1 outputted from the matrix converter illustrated in FIG. 4B-1 to which an AC voltage is applied.

FIG. 4J-1 is a graph showing an output waveform equivalent to the signal of the graph illustrated in FIG. 3D outputted from the matrix converter illustrated in FIG. 4C-1 to which an AC voltage is applied.

FIG. 4K-1 is a graph showing an output waveform equivalent to the signal of the graph shown in FIG. 3D outputted from the matrix converter shown in FIG. 4D-1 to which an AC voltage is applied.

FIG. 4L-1 is a graph showing an output waveform equivalent to the signal of the graph shown in FIG. 3D outputted from the matrix converter shown in FIG. 4E-1 to which an AC voltage is applied.

FIG. 4M-1 is a graph showing an output waveform equivalent to the signal of the graph shown in FIG. 3D outputted from the matrix converter shown in FIG. 4F-1 to which an AC voltage is applied.

FIG. 5 is a block diagram showing a hardware configuration of a controller.

FIG. 6A is a graph showing a voltage command of each phase on which the discontinuous PWM is based.

FIG. 6B is a graph showing the concept of discontinuous PWM.

FIG. 7A is a schematic diagram illustrating a two-arm conversion unit of the power converting apparatus.

FIG. 7B is a schematic diagram illustrating a three-arm (or more) conversion unit of the power converting apparatus.

FIG. 8 is an explanatory diagram for explaining a concept of a modulation method for setting a selected phase to a value corresponding to an intermediate voltage level in the second embodiment.

FIG. 9 is a schematic diagram showing an overall configuration of a power converting apparatus according to a third embodiment.

FIG. 10 is a schematic diagram showing an overall configuration of a power converting apparatus according to a fourth embodiment.

### DESCRIPTION OF THE EMBODIMENTS

The contents of U.S. Pat. No. 9,906,168 (Japanese Unexamined Patent Application Publication No. 2015-211595) are incorporated herein by reference in their entirety.

Hereinafter, embodiments of the present invention will be described with reference to the drawings. In the following description, components having substantially the same functions and configurations will be denoted by the same reference numerals, and redundant description will be made only when necessary.

### First Embodiment

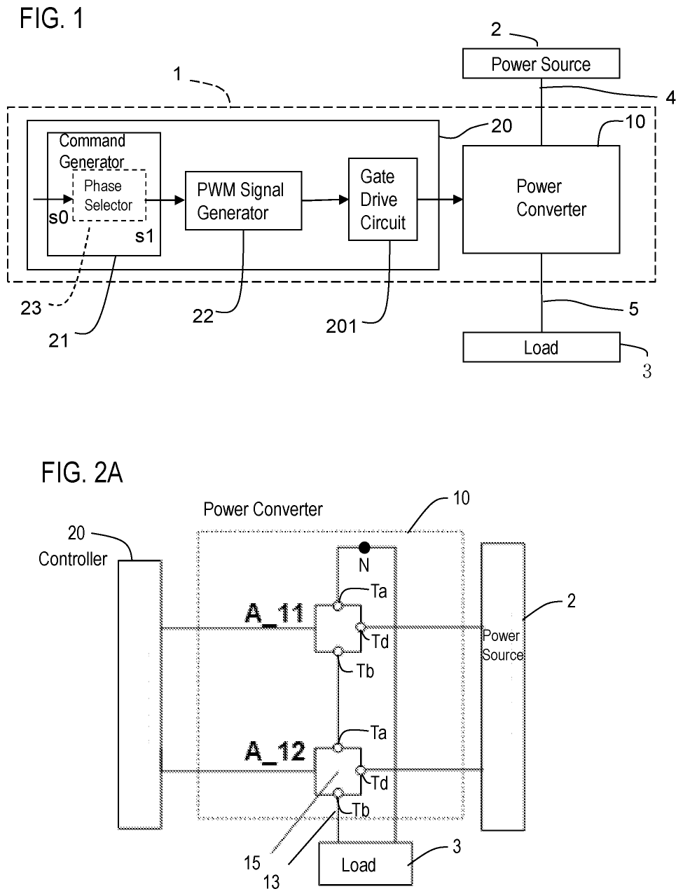

FIG. 1 illustrates a power converting apparatus 1 in which a power converter 10 includes a plurality of switching elements driven based on a PWM signal, and a controller 20 generates the PWM signal. FIG. 1 illustrates a configuration example of a power converting apparatus 1. As illustrated in FIG. 1, a power converting apparatus 1 according to the first embodiment converts power supplied from a power source 2 into predetermined power and outputs the predetermined power to a load 3. For example, when the power source 2 is a DC power source and the load 3 is an AC motor, the power converting apparatus 1 converts DC power supplied from the power source 2 into AC power and outputs the AC power to the load 3. The power source 2 may be, for example, an AC power source, and the load 3 may be, for example, a power system.

The power converting apparatus 1 includes a power converter 10 that outputs a voltage to a load 3, and a controller 20 that outputs a drive signal generated according to a voltage command to the power converter 10. The controller 20 may be referred to as control circuitry. The power converter 10 includes a plurality of switching elements driven based on a drive signal (for example, a PWM signal output from the controller 20), and is connected between the power source 2 and the load 3. The power converter 10 is connected to the power source 2 via an input line 4 (for simplicity the input line is shown as a single line in FIG. 1). The power converter 10 outputs, for example, single-phase or multi-phase AC voltage power to the load 3 via an output line 5 (in FIG. 1, the output line is illustrated by a single line for simplification) provided between the power converter 10 and the load 3.

The controller 20 generates the PWM signal such that the first period during which the 0 voltage is output and the second period during which the non 0 voltage is output are adjusted in accordance with the voltage command, or such that the first period during which the non 0 voltage value is output and the second period during which the non 0 voltage value is output are adjusted in accordance with the voltage command. In addition, the controller 20 causes the power converter 10 to output the PWM signal set such that one first period and one or more second periods are present in the update cycle of the voltage command. For example, controller 20 outputs, for each update cycle of voltage command, a PWM signal obtained by combining one first period and one or more second periods within the update cycle of voltage command.

The controller 20 may include a command generator 21 and a PWM signal generator 22. The command generator 21 generates a voltage command and outputs the voltage command to the PWM signal generator 22. The voltage command is a signal whose voltage value or the like is referred to when the PWM signal is generated. For example, the voltage command disclosed herein can also be regarded as a reference voltage, and can include one or more phase voltage commands respectively corresponding to one or more phases of the AC voltage output from the power converter 10. The command generator 21 can maintain or change the voltage value of the voltage command. For example, the command generator 21 updates the voltage value of the voltage command for each predetermined update period based on one or more predetermined conditions. The PWM signal generator 22 generates a carrier signal, compares the voltage command with the carrier signal to generate a PWM signal, and outputs the PWM signal to the power converter 10. The carrier signal is a signal to be compared with the voltage command to generate the drive signal. In many cases, the carrier signal comprises a triangular wave. In most cases, the maximum pulse width of the PWM signal is shorter than one cycle of the carrier signal. The PWM signal generator 22 compares the carrier signal with the voltage command, generates a PWM signal such that ON/OFF of a pulse wave is inverted before and after the carrier signal and the voltage command become equal to each other, and outputs the PWM signal to the gate drive circuit 201. This technique is well known in the art such as in U.S. Pat. No. 9,906,168 and will not be described in further detail.

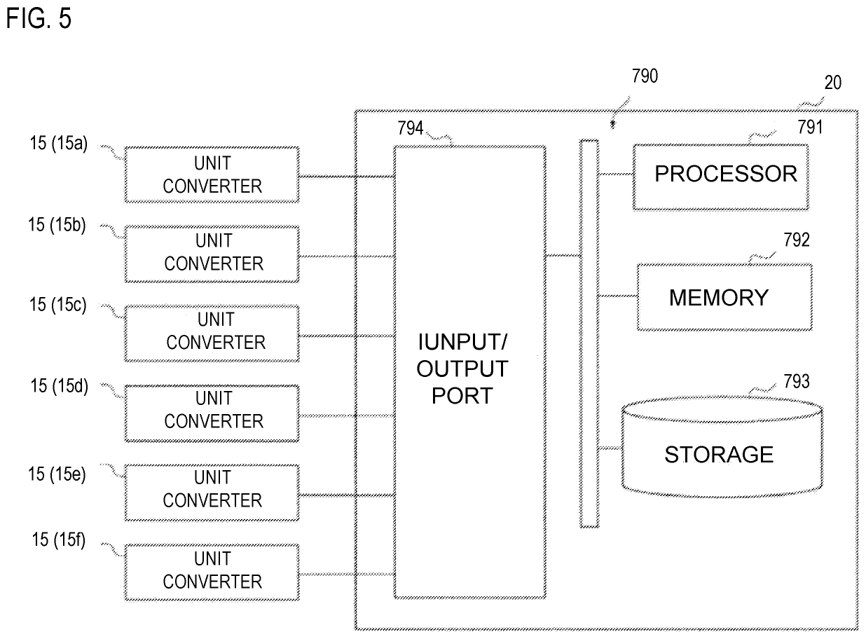

FIG. 5 illustrates an example of a hardware configuration of the controller 20. As shown in FIG. 5, the controller 20 includes a circuit 790. The circuitry 790 includes one or more processors 791, memory 792, storage 793, and input/output ports 794. The storage 793 stores a program for configuring each functional module of the controller 20. The storage 793 can include a computer-readable device such as a nonvolatile semiconductor memory mounted on a substrate or the like, but may be a storage device such as an external hard disk. The memory 792 temporarily stores a program loaded from the storage 793, a calculation result of the processor 791, and the like. The processor 791 may be configured to execute programs in cooperation with the memory 792 to configure and/or control one or more functional modules of the power converter. The input/output port 794 inputs/outputs a signal to/from each single-phase power converting cell 15 in response to a command from the processor 791.

The circuitry 790 may include hardware, software, firmware, or any combination thereof. The circuitry 790 can perform one or more of these functions by executing a program. In some examples, the circuitry 790 may perform at least a portion of the functions by using one or more integrated circuits, such as a dedicated logic circuit or an application-specific integrated circuit (ASIC).

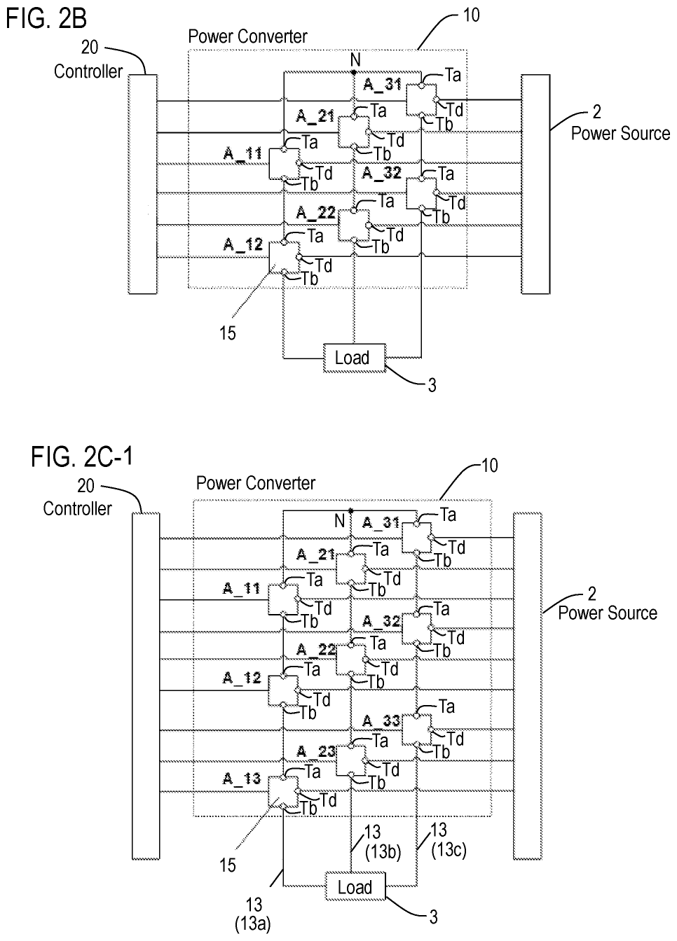

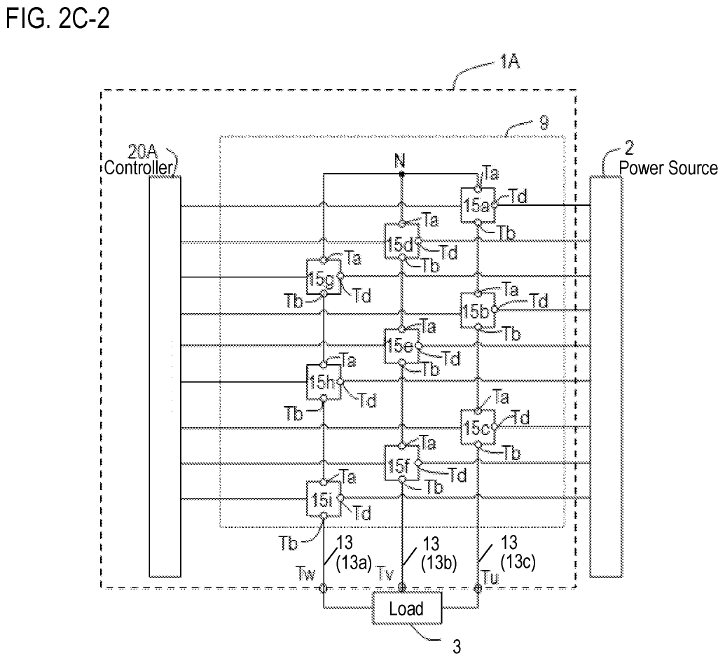

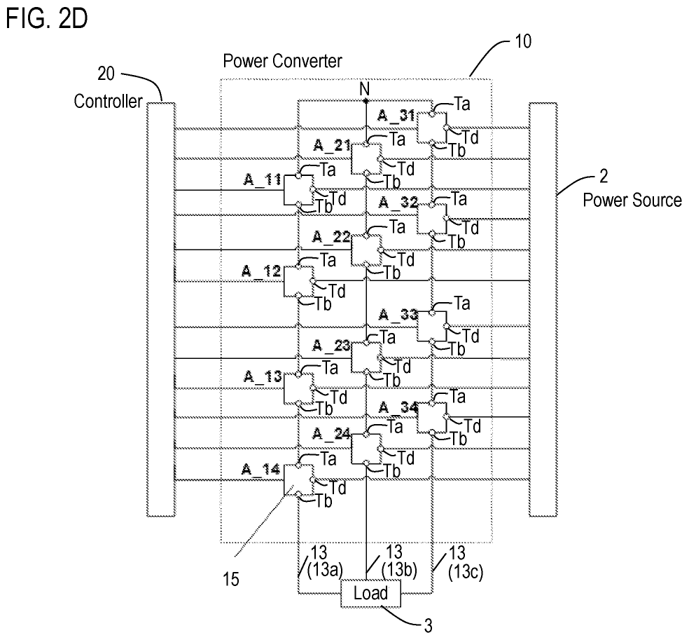

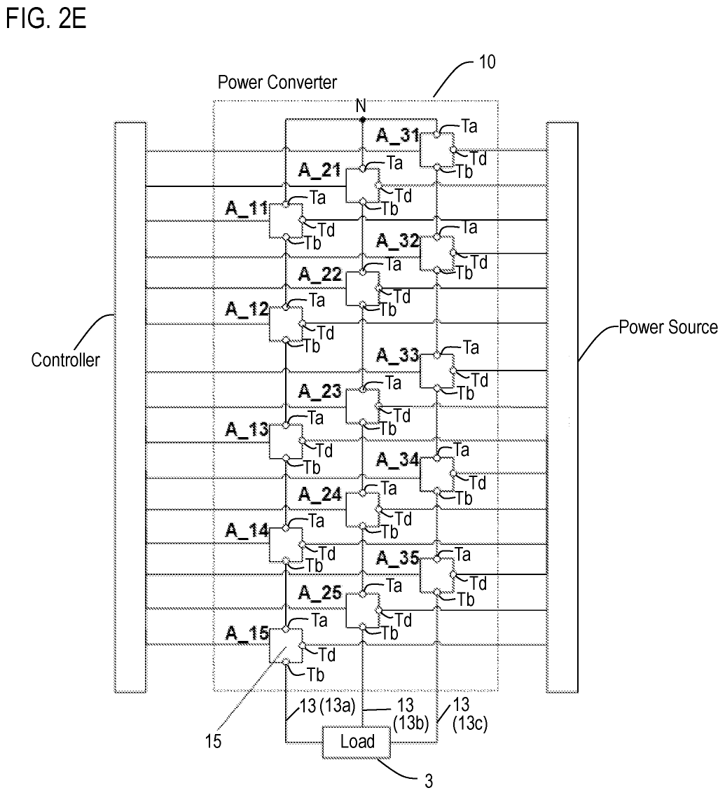

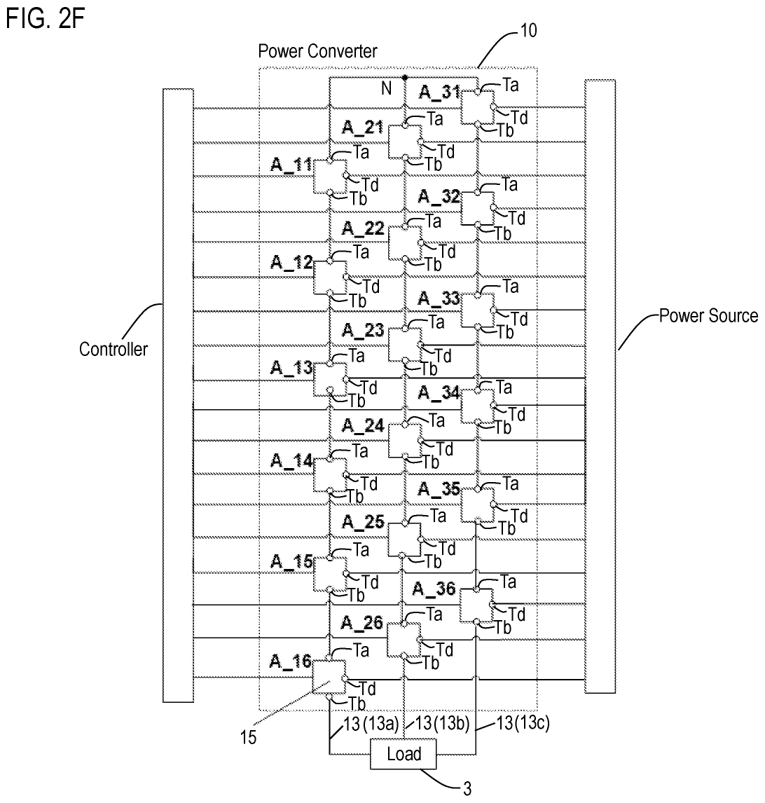

The power converting apparatus 1 includes one or more series multiplex power converters 13 in which a plurality of single-phase power converting cells (unit converters) 15 constituting an output phase to a load shown in FIG. 2A of the drawing are electrically connected in series to each other. Each series multiplex power converter 13 constitutes one phase that outputs a phase voltage to the load. The one or more series multiplex power converters 13 each have a plurality of single-phase power converting cells 15. As shown from FIG. 2B to FIG. 2F, the power converting apparatus 1 may include a plurality of series multiplex power converter 13 as one or more series multiplex power converter 13. In FIG. 2B to FIG. 2F, different series multiplex power converter 13 are shown as 13a to 13c. The number of single-phase power converting cell 15 connected in series is not limited, and three or more single-phase power converting cells s can be configured as shown in FIG. 2C-1, FIG. 2C-2, FIG. 2D, FIG. 2E, and FIG. 2F. The present invention can be applied to all the configurations of the power converting apparatus 1 shown in FIGS. 1, 2A, 2B, 2C-1, 2C-2, 2D, 2E, and 2F.

In FIG. 2C-2, the single-phase power converting cell 15 are distinguished from each other as 15a to 15i. The single-phase power converting cell 15 that output different phases (the U-phase, the V-phase, and the W-phase) (the plurality of single-phase power converting cells 15 constituting the different series multiplex power converters 13a to 13c) may be distinguished and referred to as a first single-phase power converting cell 15, a second single-phase power converting cell 15, and a third single-phase power converting cell 15. For example, in FIG. 2C-2, the single-phase power converting cell 15a to 15c may be referred to as a first single-phase power converting cell 15, the single-phase power converting cell 15d to 15f may be referred to as a second single-phase power converting cell 15, and the single-phase power converting cell 15g to 15i may be referred to as a third single-phase power converting cell 15. One ends of outputs of the plurality of first single-phase power converting cell 15a to 15c are connected to the neutral point N, and the other ends of the outputs are connected to the U-phase terminals of the load 3 via the output terminals Tu. One end of outputs of the plurality of second single-phase power converting cell 15d to 15f is connected to the neutral point N, and the other end of the outputs is connected to the V-phase terminal of the load 3 through the output terminal Tv. One ends of outputs of the plurality of third single-phase power converting cell 15g to 15i are connected to the neutral point N, and the other ends of the outputs are connected to the W-phase terminals of the load 3 via the output terminals Tw. Phase currents Iu flows between the first single-phase power converting cell 15a to 15c and the terminals Tu of the load 3. Phase current Iv flows between each of the second single-phase power converting cell 15d to 15f and the load 3. Phase current Iw flows between each of the third single-phase power converting cell 15g to 15i and the load 3. In the following description, the phase currents Iu, Iv, and Iw may be collectively referred to as an output phase current Iuvw. The circuits shown in FIG. 2B, FIG. 2C-1, FIG. 2D, FIG. 2E and FIG. 2F have similar features. These circuits are, for example, circuits that output power to a three-phase load. In these figures, the load 3 is, for example, a three phase AC motor. FIG. 2A is a circuit that outputs power to a single-phase load. In these drawings, the load 3 is, for example, a single-phase AC motor of an air conditioner or a household electrical appliance.

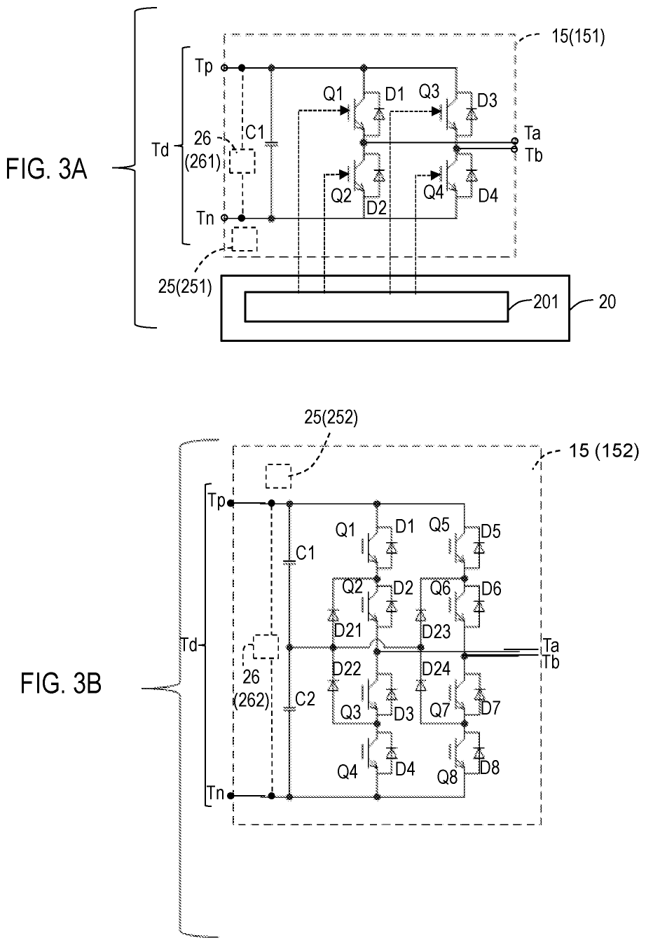

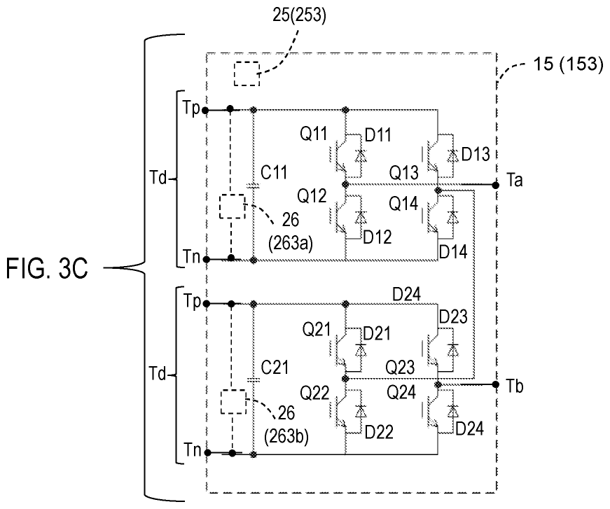

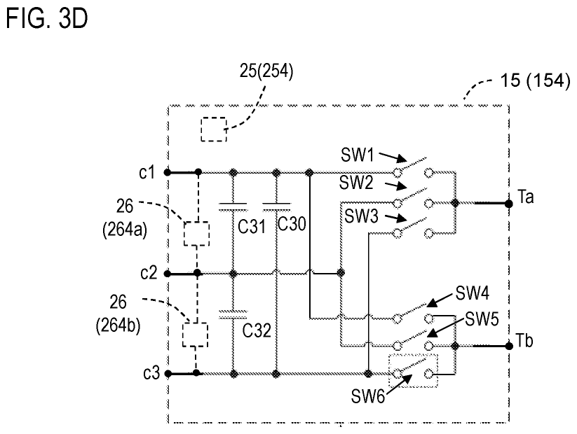

Each of the plurality of single-phase power converting cells 15 includes a plurality of switching elements. The single-phase power converting cell 15 are configured to switch the driving of the plurality of switching elements in response to a drive signal generated by the controller 20 and output an output voltage, and includes function to convert the input power into a variable-frequency output including 0 Hz as a direct current and a variable voltage. The single-phase power converting cell 15 can be configured as shown in FIGS. 3A, 3B-1, 3B-2, 3C, 3D, 3E-1, and 3E-2. FIG. 3A shows a configuration example of the single-phase power converting cell 151 which is one example of the single-phase power converting cell 15 and a controller 20.

As shown in FIG. 3A, the single-phase power converting cells 151 include input terminals Tp and Tn and outputs terminals Ta and Tb. The input terminal Tp is connected to the positive electrode of the power source 2, and the input terminal Tn is connected to the negative electrode of the power source 2. The input terminals Tp and Tn are collectively referred to as Td. A potential difference between the input terminals Tp and Tn is represented by Vd. Ta, Tb, and Td are shown in FIG. 2A, FIG. 2B, FIG. 2C—1, FIG. 2D, FIG. 2E, and FIG. 2F. The output terminals Ta and Tb are connected to a load 3. The power source 2 is a DC power source.

The single-phase power converting cell 151 includes switching elements Q1 to Q4 and a capacitor C1. The switching elements Q1 to Q4 are bridge-connected to each other and are connected to the load 3 via the terminals Ta and Tb. The protection rectifying elements D1 to D4 are connected to each of the switching elements Q1 to Q4 in parallel (hereinafter referred to as anti-parallel connection) such that the direction in which current flows is opposite. The switching elements Q1 to Q4 are, for example, semiconductor devices such as IGBTs and MOSFETs (Metal-Oxide-Semiconductor Field-Effect-Transistors). The protection rectifying elements D1 to D4 are diodes, for example.

The controller 20 includes a gate drive circuit 201. The gate drive circuit 201 of the controller 20 amplifies the PWM signal output from the controller 20 and outputs the amplified PWM signal to the gates of the switching elements Q1 to Q4. Thus, the single-phase power converting cells 151 convert the DC voltage input from the power source 2 via the input terminals Tp and Tn into an AC voltage by the switching operation of the switching elements Q1 to Q4, and output the converted AC voltage to the load 3 via the terminals Ta and Tb.

The controller 20 generates a PWM signal by the PWM signal generator 22 illustrated in FIG. 1 and outputs the PWM signal to the gate drive circuit 201. The gate drive circuit 201 outputs the PWM signal as pulse waves L1, L2, 4, L3, and L4 to each of the gates of the switching elements Q1 to Q4. The single-phase power converting cells 151 shown in FIG. 3A can output pulse wave of voltage +Vd by turning on Q1 and Q4 to set the potential of the output-terminal Tb as a reference potential. By turning on Q2 and Q3, a pulse wave having a voltage of −Vd can be output. The single-phase power converting cell 151 can be applied to all the single-phase power converting cells shown in FIG. 2A to FIG. 2F.

The single-phase power converting cell 15 is not limited to the single-phase power converting cell 151 described above. FIG. 3B is a schematic diagram illustrating another example 152 of the single-phase power converting cell 15. In this figure, the single-phase power converting cell 152 is the three-level inverter. The unit power converting apparatus 152 includes a circuit in which two capacitors C1 and C2 connected in series, four switching elements Q1 to Q4 connected in series, and four switching elements Q5 to Q8 connected in series are connected in parallel to each other. Further, the unit power converting apparatus 152 includes two diodes D21 and D22 connected in series between a connection point of the switching elements Q1 and Q2 and a connection point of the switching elements Q3 and Q4, and two diodes D23 and D24 connected in series between a connection point of the switching elements Q5 and Q6 and a connection point of the switching elements and. Q7 and Q8.

In the single-phase power converting cells 152, a connection point between the diodes D21 and D22, a connection point between the diodes D23 and D24, and a connection point between the capacitors C1 and C2 are connected. The connection point between the switching elements Q2 and Q3 is connected to the Terminal Ta, and the connection point between the switching elements Q6 and Q7 is connected to the Terminal Tb. The input terminals Tp and Tn are collectively referred to as Td, and the potential difference between the input terminals Tp and Tn is referred to as Vd. As the switching elements Q1 to Q8, for example, semi-conductor switches such as IGBTs are used. The terminals Ta and Tb of the single-phase power converting cell 152 can output voltages of three levels of +Vd, +Vd/2, and 0 with the potential of the input terminal Tn as a reference potential. Therefore, the single-phase power converting cell 152 can output five kinds of voltage pulse waves of +Vd, +Vd/2, 0, −Vd/2, and −Vd with the potential of the output terminal Tb as a reference potential.

FIG. 3C is a schematic diagram illustrating yet another example 153 of a single-phase power converting cell 15. The single-phase power converting cell 153 is formed by connecting the outputs of the two single-phase power converting cell 151 in series and multiplexing them. The single-phase power converting cell 153 is a circuit in which the output terminal Tb of the single-phase power converting cell 151 of the first stage is connected to the output terminal Ta of the single-phase power converting cell 151 of the second stage. In FIG. 3B, the capacitors of the single-phase power converting cell 151 in the first stage are represented by C11, the switching elements are represented by Q11 to Q14, and the protection rectifying elements are represented by D11 to D14, and the capacitors of the single-phase power converting cell 151 in the second stage are represented by C21, the switching elements are represented by Q21 to Q24, and the protection rectifying elements are represented by D21 to D24. Because of the above-described circuit configuration, the single-phase power converting cells 153 can output five types of voltage pulse waves, +2 Vd, +Vd, 0, −Vd, and −2 Vd.

FIG. 3D is a schematic diagram illustrating yet another example 154 of the single-phase power converting cell 15. The single-phase power converting cell 154 is a matrix converter. The single-phase power converting cells 154 includes bi-directional switches SW1 to SW6 (hereinafter collectively referred to as a bi-directional switch SW). The terminals Tb are connected to one ends of the bi-directional switches SW1 to SW3, and the terminals Ta are connected to one ends of the bi-directional switches SW4 to SW6. The bi-directional switch SW2 is connected to the other end of the bi-directional switch SW4 and is further connected to the terminal c1. Similarly, the other end of the bi-directional switch SW2 is connected to the other end of the bi-directional switch SW5 and further connected to the terminal c2. The other end of the bi-directional switch SW3 is connected to the other end of the bi-directional switch SW6 switch and further connected to the terminals c3.

Each of the bi-directional switches SW1 to SW6 can be constituted of, for example, two elements of which two unidirectional switching elements are connected in anti-parallel. For example, an IGBT having a reverse blocking characteristic is used as a switching element. The reverse blocking characteristic is a characteristic that the switching element can maintain an OFF state with respect to a voltage having a polarity opposite to a single direction in which a switching element flows current. As the switching elements, for example, two sets of IGBTs and protection diodes connected in anti-parallel may be prepared, and the IGBTs may be connected in series such that the emitters or the collectors of the IGBTs are connected to each other. Then, a signal is input to the gate of the semiconductor switch to control ON/OFF of each semiconductor switch, thereby controlling the energization direction. The capacitors C31 to C33 connect mutually different terminals c1, c2, c3. The single-phase power converting cell 154 can output five kinds of voltage pulse waves with the potential of the terminal Tb as a reference potential by switching the connection of the bi-directional switches SW1 to SW6 according to two potential differences of the potential difference V12 between the terminal c1 and the terminal c2 and the potential difference V23 between the terminal c2 and the terminal c3.

Above single-phase power converting cell 154 shows a case where the power source 2 is a DC power source, but the power source 2 may be an AC power source. For example, an inductance is provided between the capacitors C31 to C33 and the terminals c1, c2, c3 in the single-phase power converting cells 154 to form an LC filter, and the terminals c1, c2, c3 may be connected to a three-phase AC power source circuit. When the three phase AC power source circuit is a transformer, the leakage inductance of the transformer may be used instead of the inductance, and the inductance may be omitted. As in the relationship between the circuits 151 and 153, the single-phase power converting cells 154 may be multiplexed. Each of the multiplexed circuits may send an output signal to each of the U-phase, V-phase and W-phase of the motor.

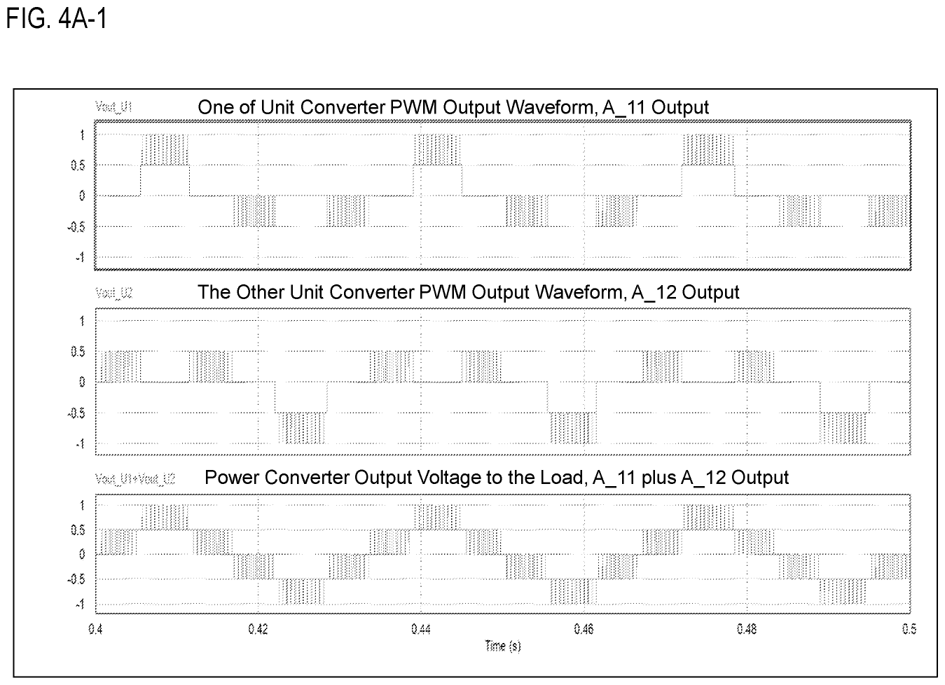

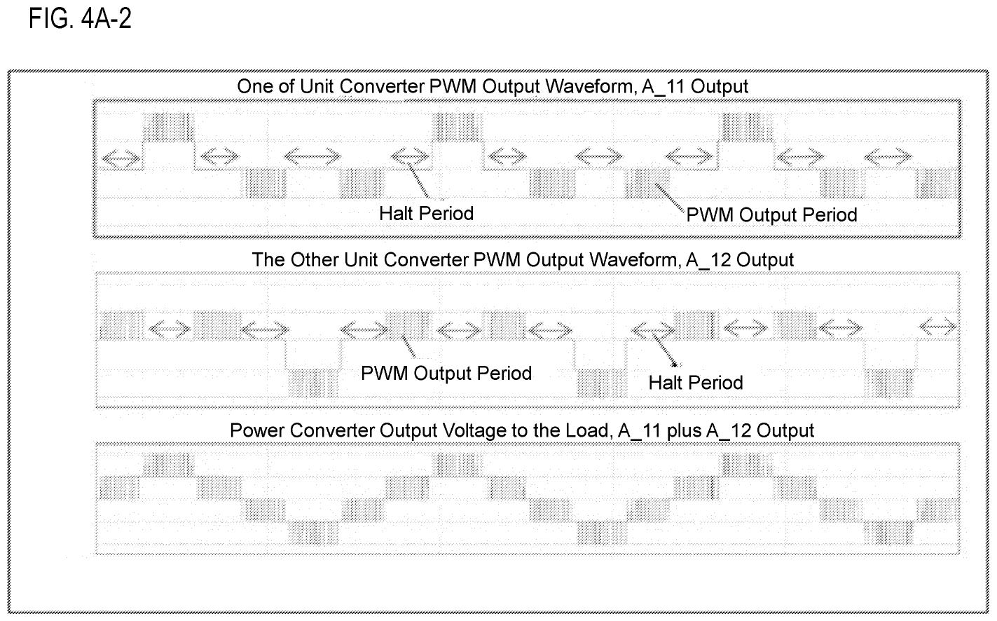

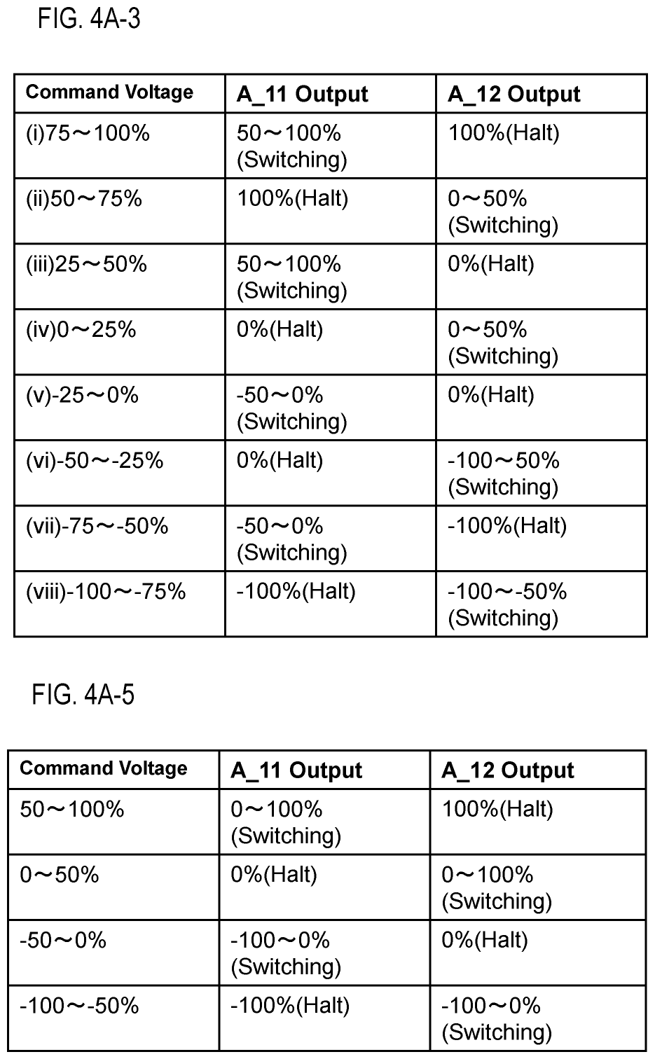

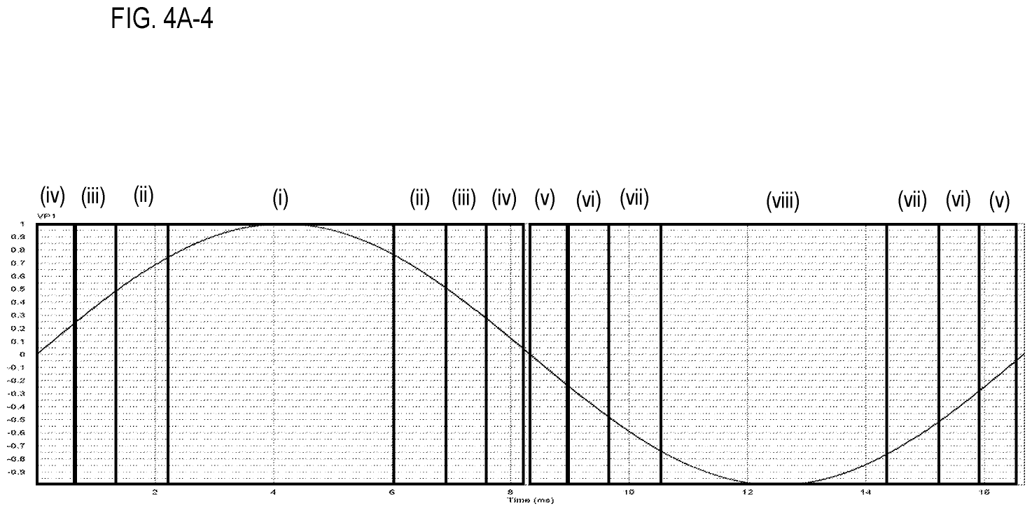

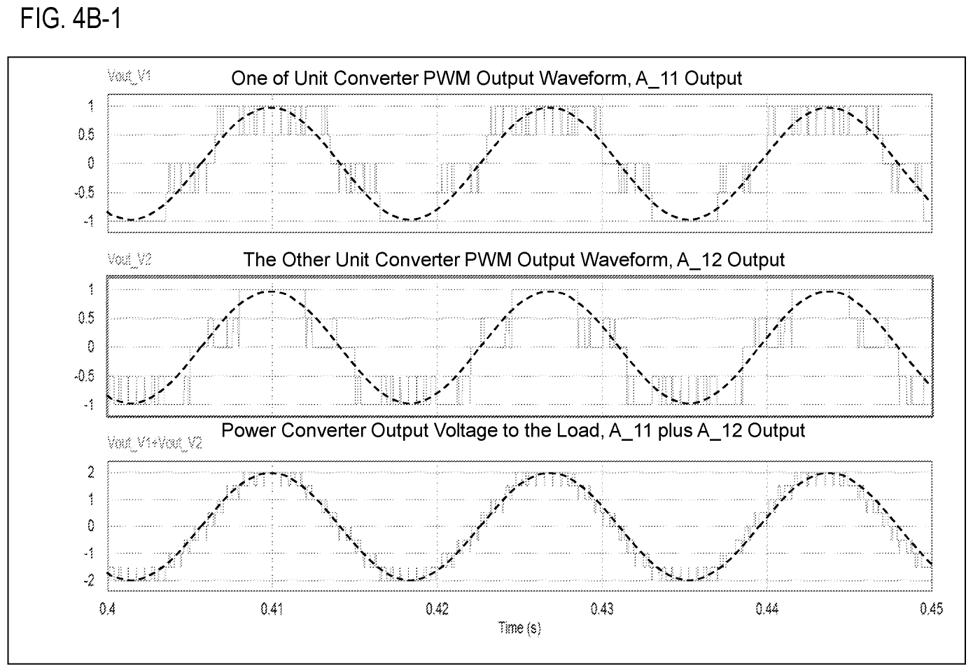

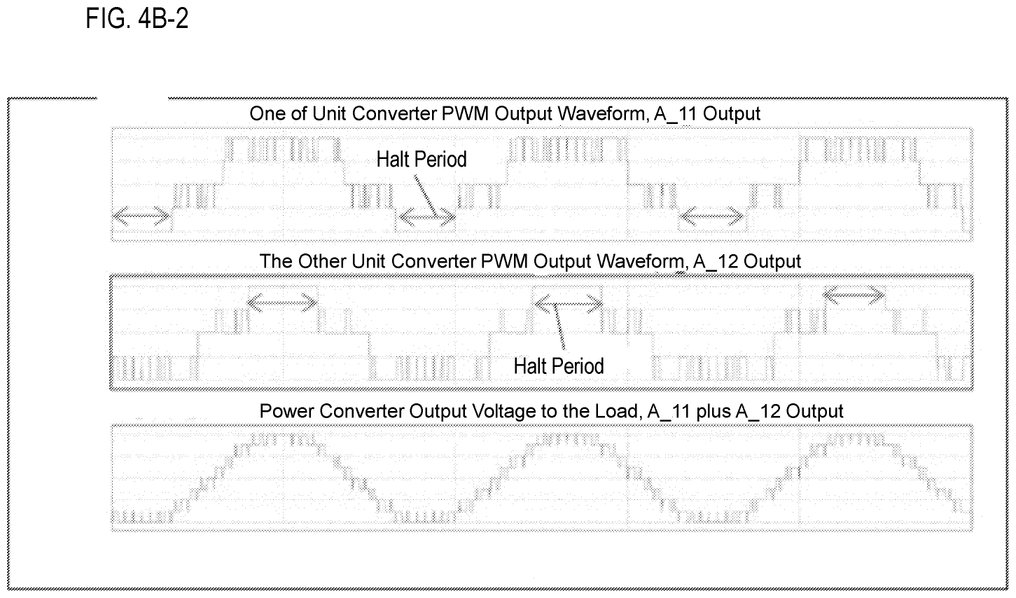

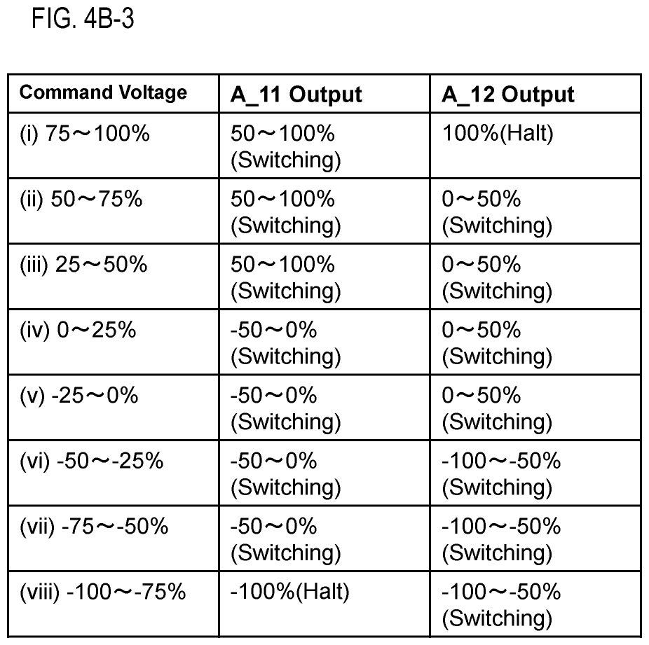

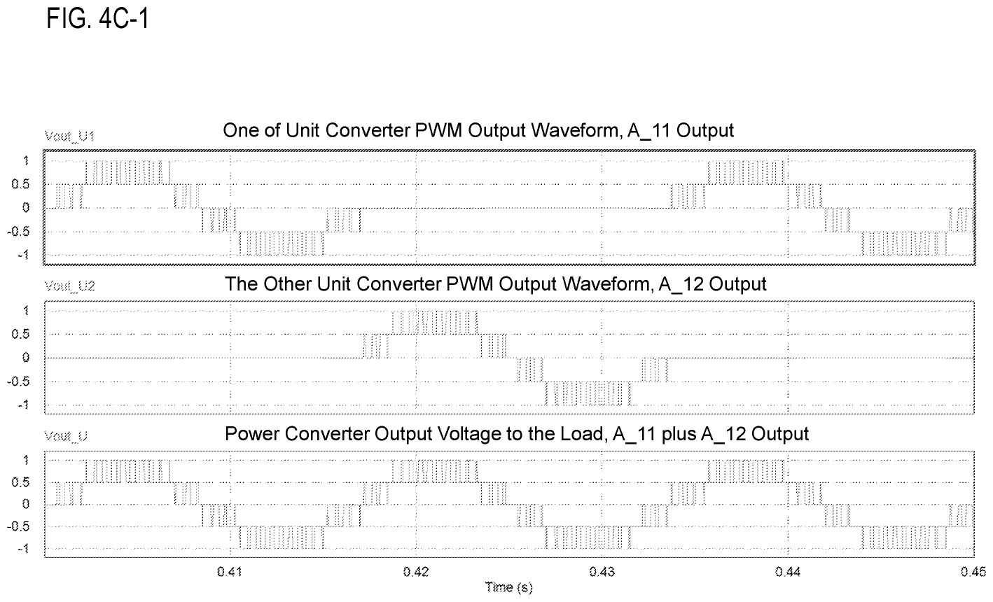

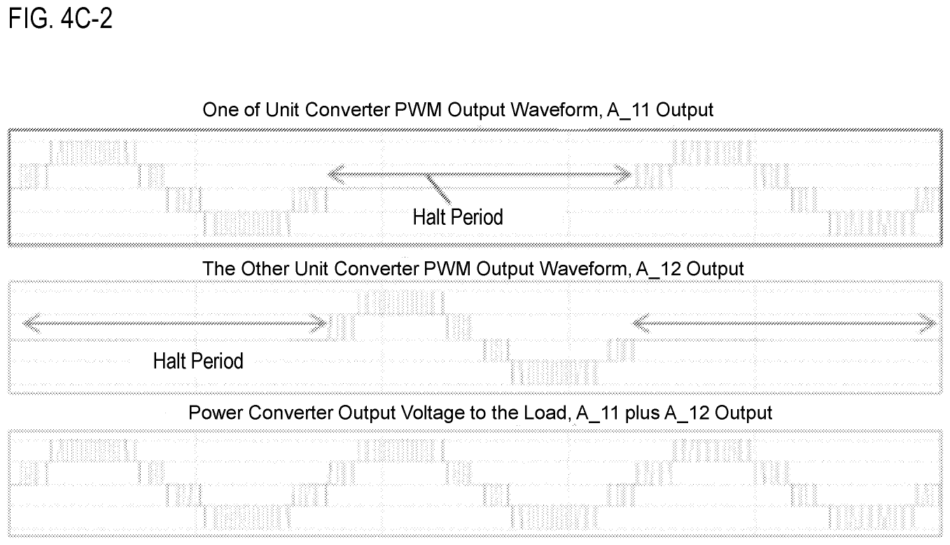

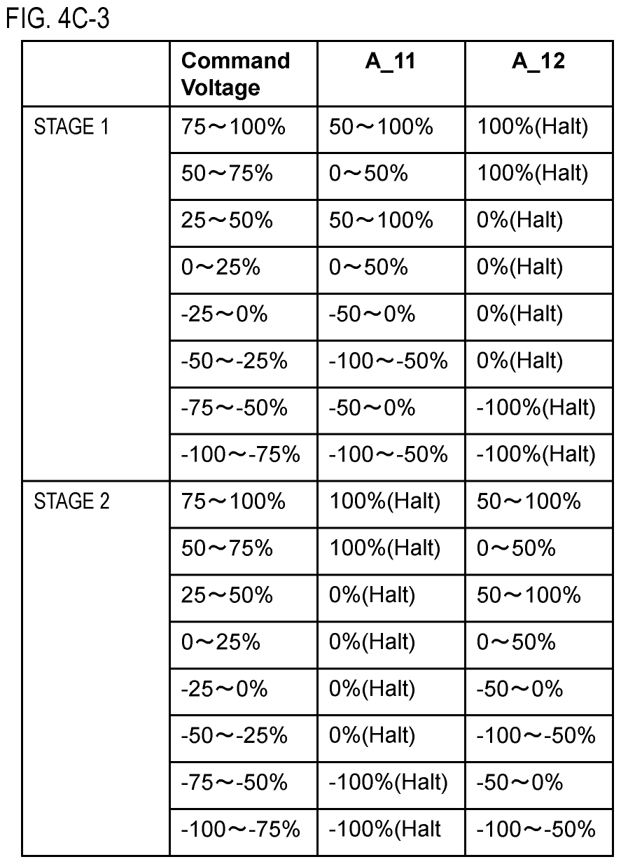

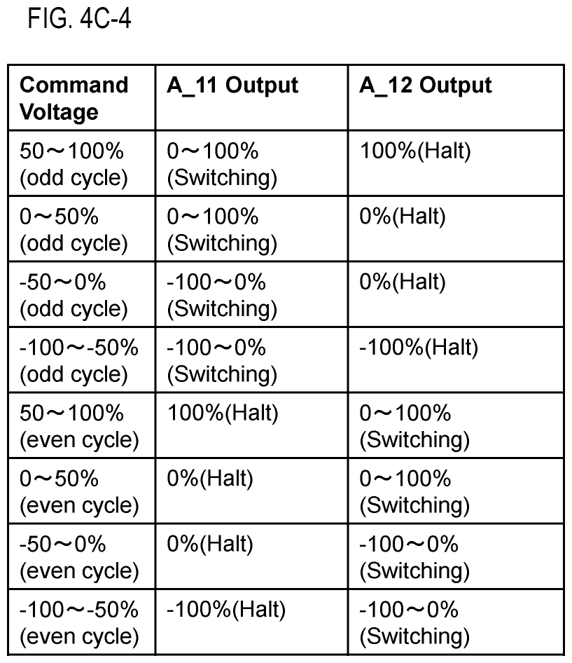

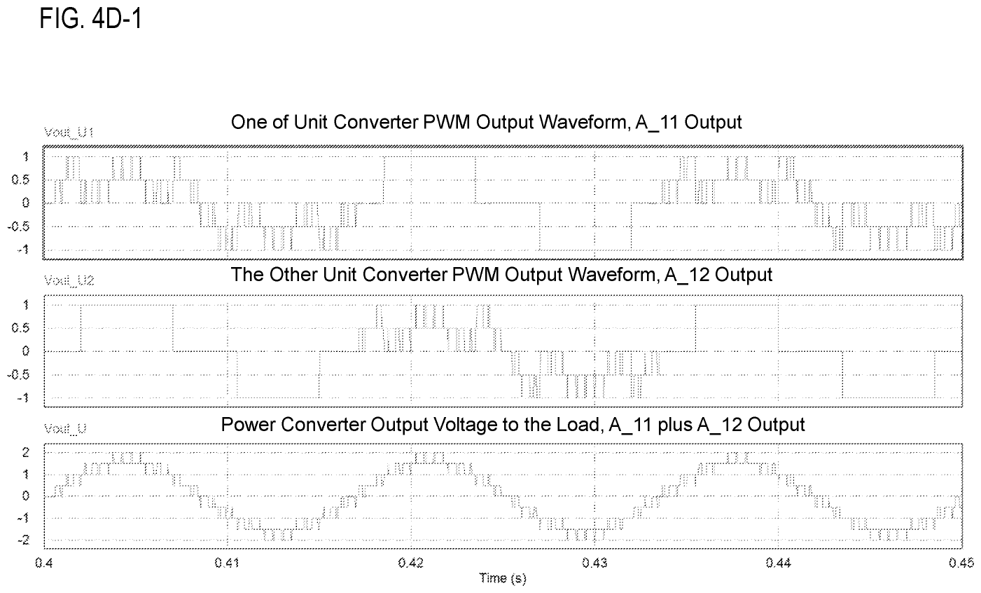

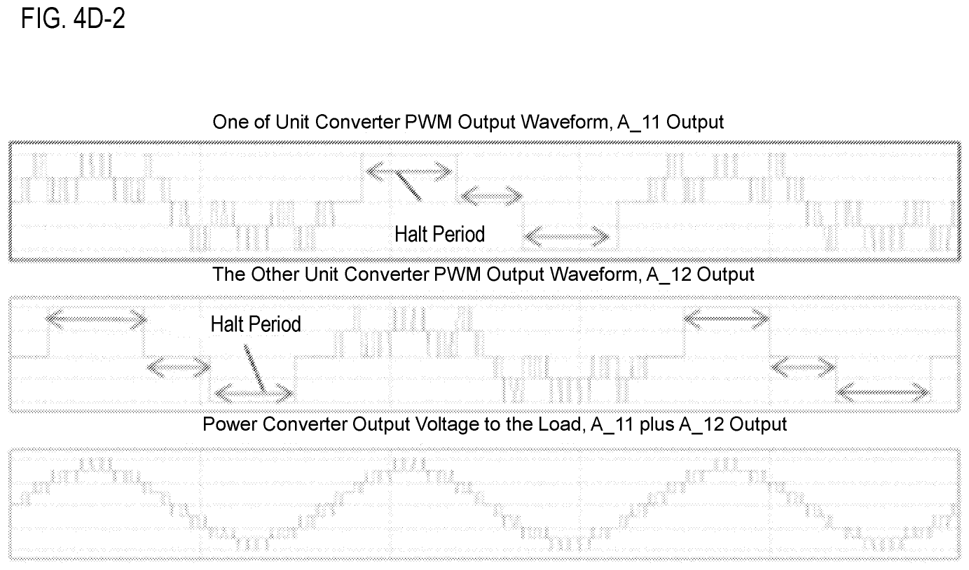

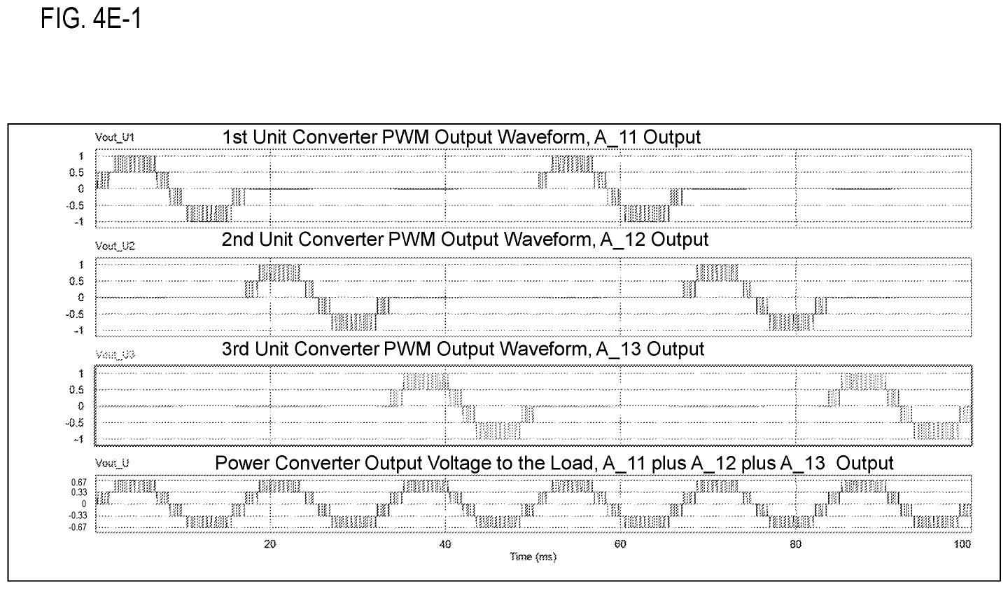

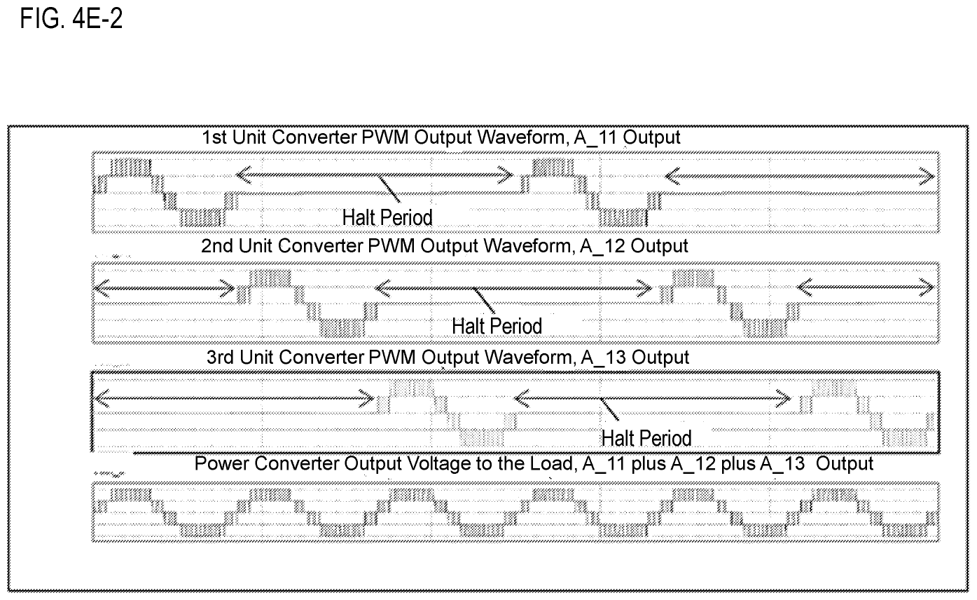

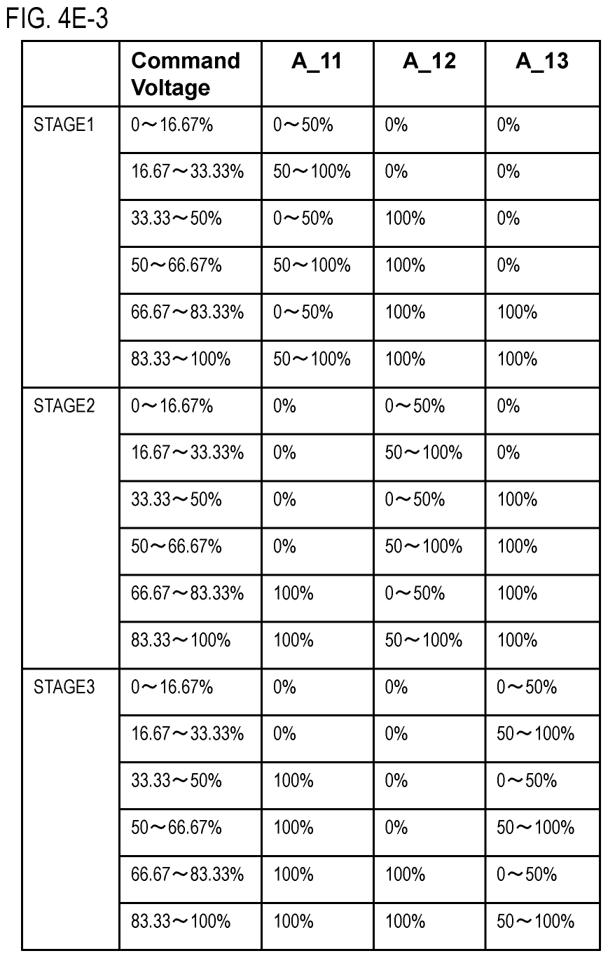

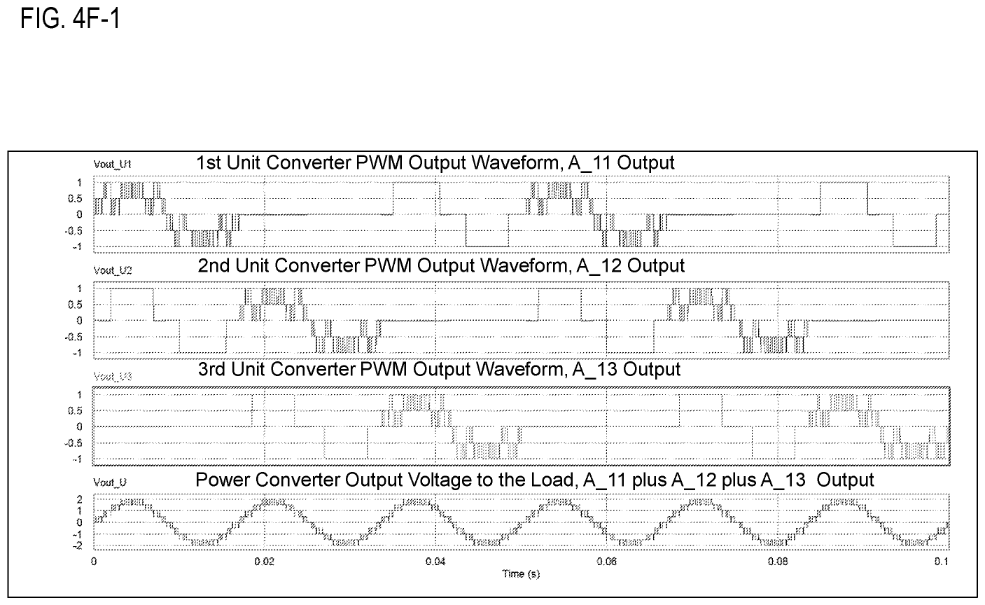

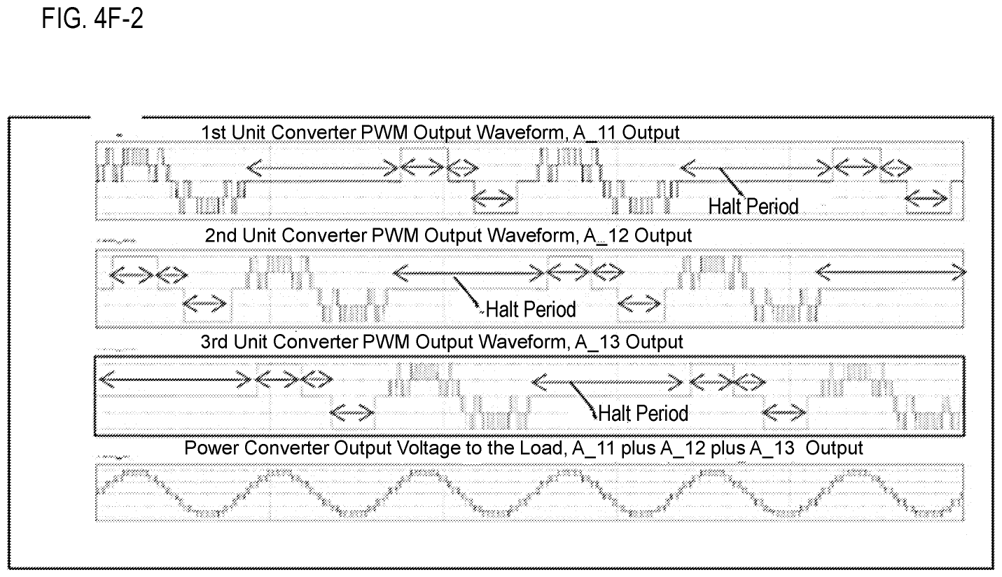

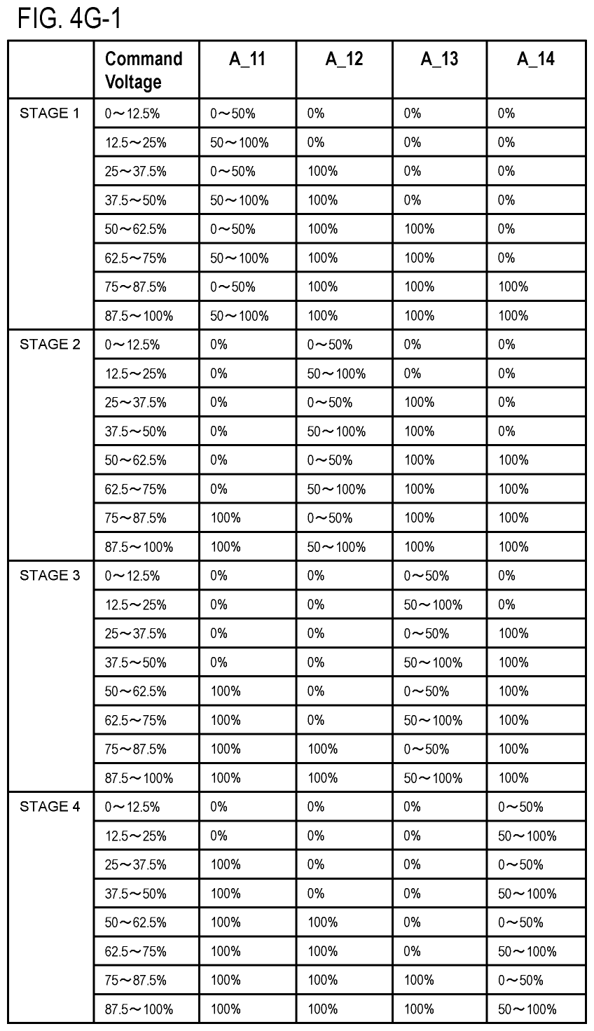

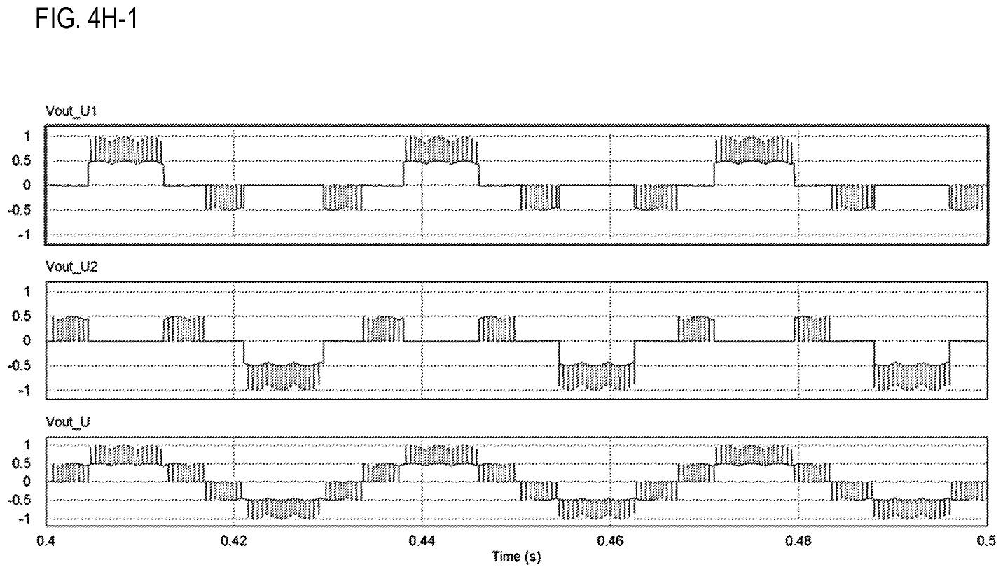

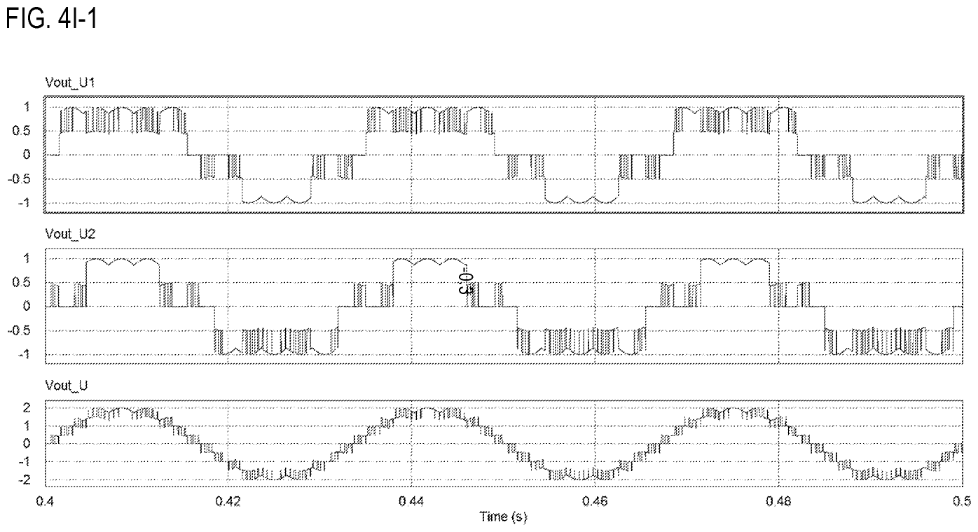

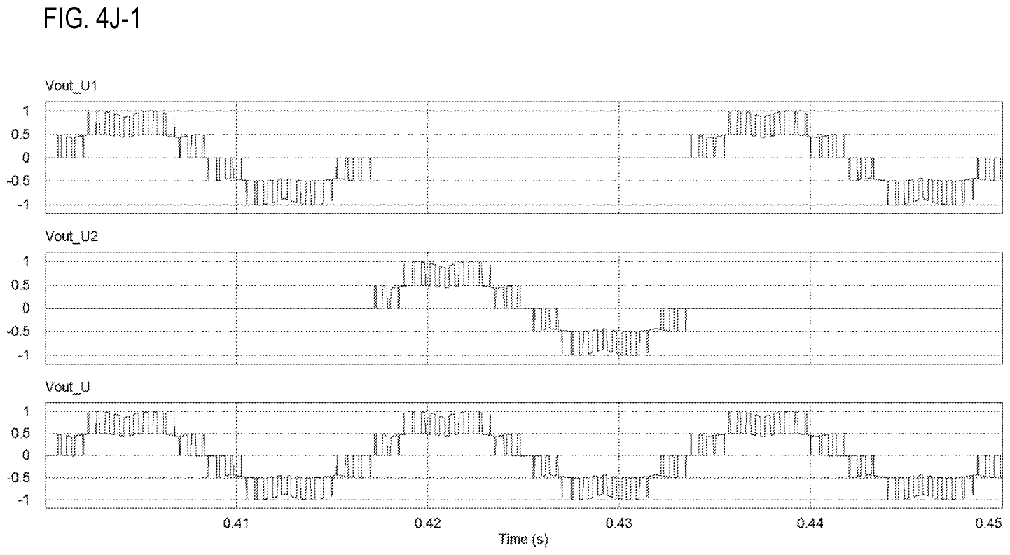

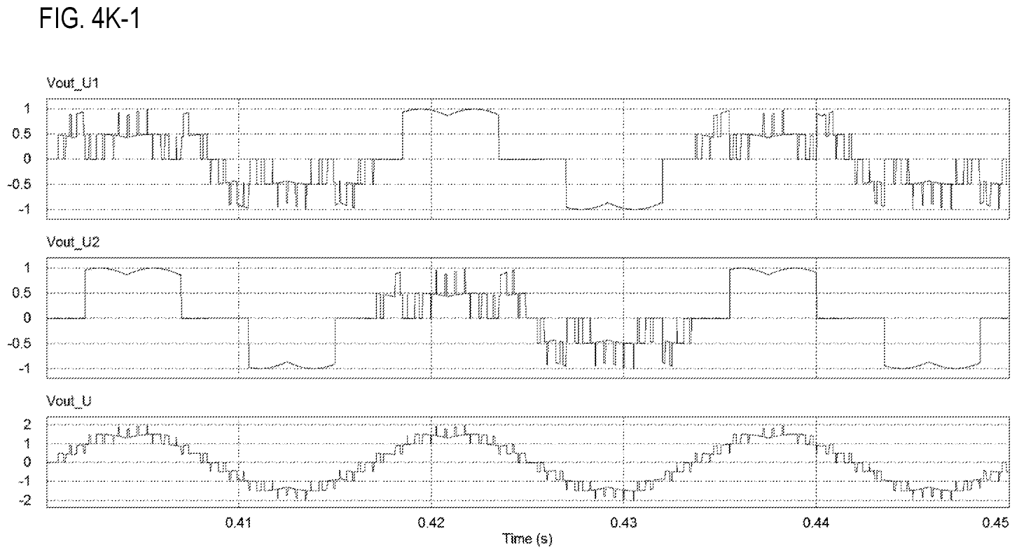

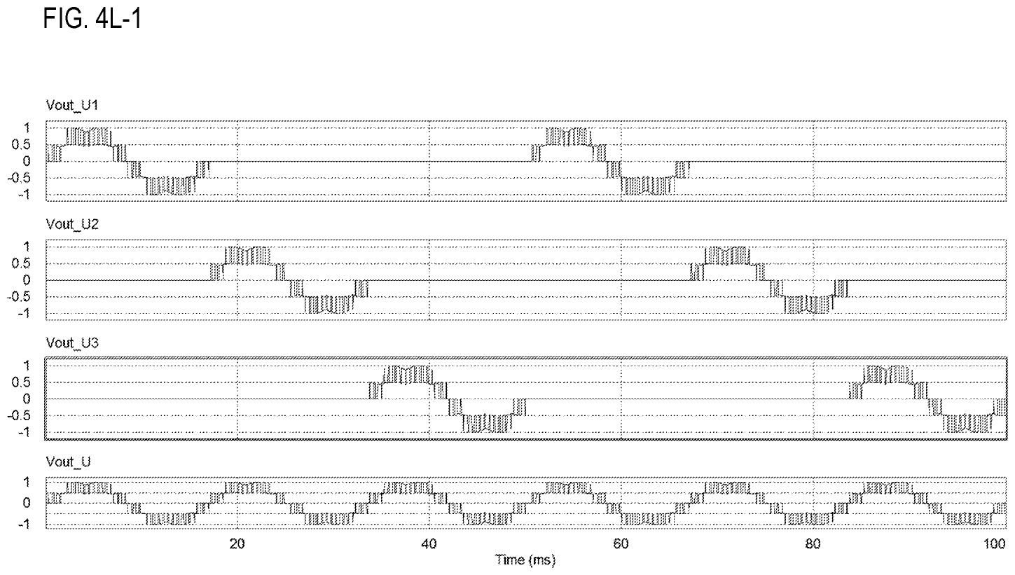

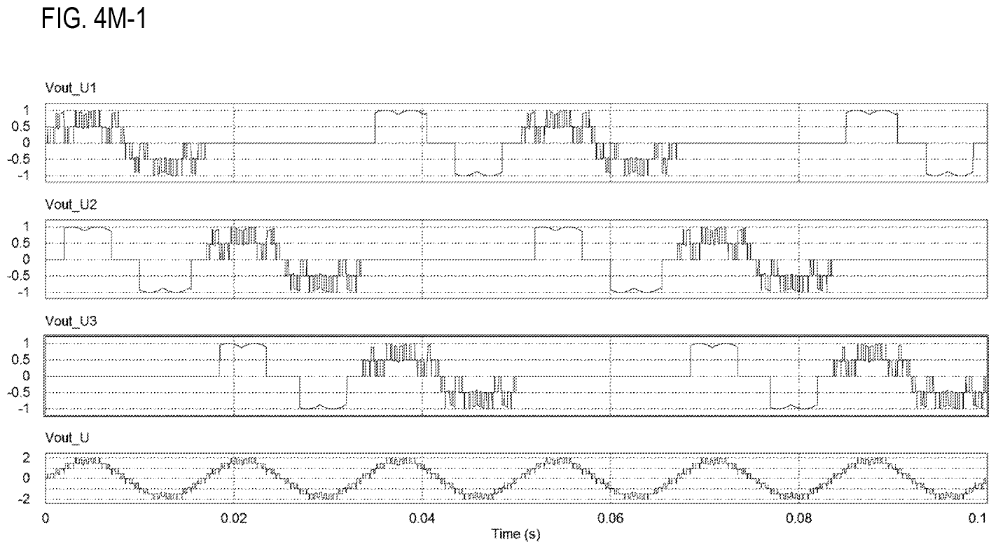

In the present embodiment, at least one single-phase power converting cell 15 among the plurality of single-phase power converting cells 15 directly connected to each other suspends PWM switching, and the remaining single-phase power converting cells 15 perform PWM switching. For example, As to a unit converter Ail and a unit converter A_12 of the single-phase power converting cells 15 in FIG. 2A, the unit converter Ail is to a halt and the unit converter A_12 performs PWM switching, or conversely, the unit converter Ail performs PWM switching and the unit converter A_12 is to a halt. FIG. 4A-1, FIG. 4A-2, FIG. 4B-1, FIG. 4B-2, FIG. 4C-1, FIG. 4C-2, FIG. 4D-1, FIG. 4D2, FIG. 4E-1, FIG. 4E-2, FIG. 4F-1, and FIG. 4F-2 are examples of generation of such waveforms. In these examples, the single-phase power converting cells 15 are configured by any one of the circuits 3B to 3D in the drawings, and the single-phase power converting cells 15 output three levels (including 0) for each of positive and negative polarities.

The “halt” of the PWM switching in the present embodiment (FIG. 4A-1, FIG. 4A-2, FIG. 4B-1, FIG. 4B-2, FIG. 4C-1, FIG. 4C-2, FIG. 4D-1, FIG. 4D2, FIG. 4E-1, FIG. 4E-2, FIG. 4F-1, and FIG. 4F-2) can take any of the voltage levels of the single-phase power converting cell 15. The numerical values on the left side of the remaining graphs other than the lowermost graph in FIG. 4A-1, FIG. 4B-1, FIG. 4C-1, FIG. 4D-1, FIG. 4E-1, FIG. 4F-1 indicate that the central level is 0, the maximum level is 1, and the minimum level is −1, among the five voltage levels that can be outputted by the single-phase power converting cell 15. In the lowermost graphs of FIGS. 4A-1, FIG. 4B-1, FIG. 4C-1, FIG. 4D-1, FIG. 4E-1, and FIG. 4F-1, it is indicated that the center level is 0, the maximum level is 2, and the minimum level is −2.

FIG. 4A-3 shows outputs of the two unit converters Ail and A_12 with respect to each command voltage in FIG. 4A-1. 100% of the command voltage of each of the unit converters Ail and A_12 corresponds to the maximum voltage in each of the unit converters A_11 and A_12. That means 100% of the command voltage of A_11 and A_12 of each single-phase power converting cell of the unit converters Ail and A_12 is, for example, Vd of the single-phase power converting cells 151 and 152 according to FIG. 3A and FIG. 3B, 2 Vd of the single-phase power converting cell 153 according to FIG. 3C, or the maximum voltage among five levels of the single-phase power converting cell 154 according to FIG. 3D. 100% of the command voltage corresponds to the maximum voltage (2 in the lowermost graph of FIG. 4A-1, FIG. 4B-1, FIG. 4C-1, FIG. 4D-1, FIG. 4E-1, and FIG. 4F-1) of the series multiplex power converter 13. As shown in FIG. 4A-3, by assuming N that (number of a plurality of single-phase power converting cells in the one series multiplex power converter (2 in this example)×((number of levels of the plurality of single-phase power converting cells)−1 (2 in this example))×2, the controller 20 sets voltage ranges (i) to (viii) obtained by dividing the range between the maximum and minimum voltages in one cycle of the phase voltage by a divisor of N (8 in this example), determines a halt period based on a time (one voltage range in this example) during which the phase voltage continuously exists in one voltage range or a plurality of continuous voltage ranges in each cycle, and outputs the drive signal to each of the plurality of single-phase power converting cells 15. FIG. 4A-4 shows voltage ranges (i) to (viii) corresponding to the sinusoidal voltage command. Here, the number of levels of the plurality of single-phase power converting cells 15 is x (x is an integer) when each of the single-phase power converting cell 15 constituting the series multiplex power converter 13 is x level converter. In other words, the number of levels is the number of positive voltage levels (including 0) or negative voltage levels (including 0) that can be output by each single-phase power converting cell 15.

Referring to FIG. 4A-2 and FIG. 4A-3, in the example of FIG. 4A-1, when one or more single-phase power converting cell 15 in the plurality of single-phase power converting cells 15 constituting the series multiplex power converter 13 enter the halt period, the remaining single-phase power converting cells 15 in the units connected in series enter the PWM outputting period. That is, when the unit converter A_11 enters the PWM output period, the unit converter A_12 enters the halt period, and when the unit converter A_12 enters the PWM output period, the unit converter A_11 enters the halt period. In FIGS. 4A-1 and FIG. 4A-2, since the command voltage changes only in the range from 1 to −1, the voltage range changes only in the range from (iii) to (iv). For this reason, the voltage output of each circuit is limited to three types.

Although an example of the single-phase power converting cell 15 capable of outputting voltages of three levels (including 0) for each of positive and negative polarities with an input voltage of three levels is shown in the above example, a single-phase power converting cell 151 capable of outputting voltages of two levels (including 0) for each of positive and negative polarities with an input voltage of two levels shown in FIG. 3A may be applied. In this case, the outputs of the two unit converters A_11 and A_12 for the respective command voltages are as shown in FIG. 4A-5.

FIG. 4B-3 shows outputs of the two unit converters A_11 and A_12 with respect to each command voltage in FIG. 4B-1. The definition of 100% of each of the unit converters A_11 and A_12 and the definition of 100% of the command voltage in FIG. 4B-3 are the same as the definition in FIG. 4A-3. FIG. 4B-1 illustrates a sinusoidal voltage command with a dotted line. As illustrated in FIGS. 4B-1 to 4B-3, there may be a voltage period in which both the unit converter A_11 and the unit converter A_12 are in the PWM outputting period. In the examples of FIGS. 4B-1 to 4B-3, both the unit converter A_11 and the unit converter A_12 perform switching when the command voltage is between −75% and 75%.

FIGS. 4C-1 to 4C-3 show an example in which a circuit to be switched is changed for each cycle. The definition of 100% of each of the unit converters A_11 and A_12 and the definition of 100% of the command voltage in FIG. 4C-3 are the same as the definition in FIG. 4A-3. In FIG. 4C-3, STAGE 1 indicates a voltage level adopted in an odd-numbered cycle of the phase voltage, and STAGE 2 indicates a voltage level adopted in an even-numbered cycle of the phase voltage. In FIG. 4C-1, since the command voltage changes only in the range from 1 to −1 in FIG. 4C-2, the voltage range changes only in the range from −50% to 50%. For this reason, only the case where the voltage levels of A_11 and A_12 in the halt period are 0 is shown. In this example, the halt period is determined by the time during which the phase voltage is continuously present in the plurality of continuous voltage ranges (the time corresponding to one cycle of the phase voltage).

Although an example of the single-phase power converting cell 15 capable of outputting voltages of three levels (including 0) for each of positive and negative polarities with an input voltage of three levels is shown in the above example, a single-phase power converting cell 151 capable of outputting voltages of two levels (including 0) for each of positive and negative polarities with an input voltage of two levels shown in FIG. 3A of may be applied. In this case, the outputs of the two unit converters A_11 and A_12 for the respective command voltages are as shown in FIG. 4C-4.

FIG. 4A-1 to FIG. 4A-3, FIG. 4B-1 to FIG. 4B-3, and FIG. 4C-1 to FIG. 4C-3 are at the same voltage level in the halt period, but may be at different voltage levels for each halt period. FIGS. 4D-1 and 4D-2 show such an example. FIG. 4C-3 shows outputs of the two unit converters A_11 and A_12 with respect to each command voltage in FIG. 4D-1. In FIGS. 4D-1 and 4D-2, the voltage outputted from the unit converters A_11 changes from 100% to 0% to −100% in four consecutive halt period. Also in the case of FIGS. 4D-1 to 4D-3, the halt period is determined by a time (time corresponding to one cycle of the phase voltage) during which the phase voltage is continuously present in the plurality of continuous voltage ranges (phase voltage corresponding to one cycle of the voltage).

FIG. 4E-1 to FIG. 4E-3 show an example, in three serially connected single-phase power converting cell 15 shown in FIGS. 2C-1 and 2C-2, the single-phase power converting cell 15 in which two of the three single-phase power converting cell 15 are deactivated within a predetermined period. The definition of 100% of each of the unit converters A_11 and A_12 and the definition of 100% of the command voltage in FIG. 4E-3 are the same as the definition in FIG. 4A-3. In FIG. 4E-3, only the case where the command voltage is positive is shown due to space limitations, but when the command voltage is negative, voltage values with negative signs are output from the three unit converters A_11, A_12, and A_13. FIG. 4E-3 shows the outputs of the three unit converters A_11, A_12, and A_13 with respect to each command voltage in FIG. 4E-1. In FIG. 4E-3, STAGE 1 indicates a voltage level adopted in (a multiple of 3+1) cycles of the phase voltage, STAGE 2 indicates a voltage level adopted in (a multiple of 3+2) cycles of the phase voltage, and STAGE 3 indicates a voltage level adopted in (a multiple of 3) cycles of the phase voltage. FIG. 4E-1 and FIG. 4E-2 show waveforms when the command voltage changes in a range from −33.33% to 33.33%. Therefore, the voltage levels of A_11, A_12, and A_13 in the halt period are 0. The unit converters A_11 and A_12 enter a halt period when the unit converter A_13 is in the PWM output period, the unit converters A_12 and A_13 enter a halt period when the unit converter A_11 is in the PWM output period, and the unit converters A_11 and A_13 enter a halt period when the unit converter A_12 is in the PWM output period. The single-phase power converting cell 15 periodically switches the stop condition based on the voltage command.

FIG. 4F-1 and FIG. 4F-2 show another example in which two of the three single-phase power converting cell 15 connected in series are deactivated within a certain period. Although FIGS. 4E-1 to 4E-3 show the same voltage level in the halt period, FIGS. 4F-1 to 4F-2 show a case where different voltage levels are provided according to the voltage range of the halt period. FIG. 4E-3 shows the outputs of the three unit converters A_11, A_12, and A_13 with respect to each command voltage in FIG. 4F-1.

Although FIGS. 4A-1 to 4F-2 show exemplary waveforms for unit converters A_11, A_12, and A_13 of the power converting apparatus 1 shown in FIGS. 2A, 2B, 2C-1, and 2C-2, similar waveforms with halt period can be used for unit converters A_14, A_15, and A_16 of the power converting apparatus shown in FIGS. 4C, 4F, and, using the techniques shown in FIGS. 2D, 2E, and 2F. FIG. 4G-1 is a table showing the switching and halt period of the respective single-phase power converting cell 15 with respect to the voltage range of the command voltage when outputting the phase voltage in the configuration of the power converting apparatus 1 shown in FIG. 2D.

As shown in these examples, the controller 20 outputs the drive signal to each of the plurality of single-phase power converting cells 15 so that the plurality of switching elements of at least one of the plurality of single-phase power converting cells 15 constituting the series multiplex power converter 13 do not perform switching at the short time interval shorter than the predetermined time interval during the halt period, and the plurality of switching elements of the remaining single-phase power converting cells 15 perform switching at the short time interval. The predetermined interval is one cycle of the carrier signal described above. As in the case of FIGS. 4D-1 to 4D-3 and FIGS. 4F-1 to 4F-2, the voltage level may change in the continuous voltage range (for example, the operation of the unit converter A_13 in STAGE 1 and STAGE 2 in FIG. 4E-3). However, even in such a case, since it is much longer than one cycle of the carrier signal, the switching at the short time interval is not performed.

In addition, as is clear from FIG. 4A-3, FIG. 4B-3, FIG. 4C-3, FIG. 4D-3, FIG. 4E-3, and FIG. 4G-1, in each of the plurality of single-phase power converting cells 15, the controller 20 outputs a drive signal to each of the plurality of single-phase power converting cells 15 such that the plurality of single-phase power converting have equal number of voltage ranges in which the plurality of switching elements do not perform the switching at the short time interval in a unit time obtained by multiplying the time of one cycle of the phase voltage by the number of the plurality of single-phase power converting cells 15 in one series multiplex power converter 13. As is clear from the examples of FIG. 4C-3, FIG. 4D-3, FIG. 4E-3, and FIG. 4G-1, the cycle of the halt period is changed for each cycle of the phase voltage so that the halt period is equally provided. Therefore, the controller 20 outputs the drive signal to each of the plurality of single-phase power converting cells 15 so that the total sum of the halt period of the plurality of single-phase power converting cells 15 in the above-described unit time is substantially equal.

Although examples in FIG. 4A-1, FIG. 4A-2, FIG. 4B-1, FIG. 4B-2, FIG. 4C-1, FIG. 4C-2, FIG. 4D-1, FIG. 4D-2, FIG. 4E-1, FIG. 4E-2, FIG. 4F-1, FIG. and 4F-2 shows a case where the power source 2 is a direct-current power source, the power source 2 may be an alternating-current power source. FIG. 4H-1, FIG. 4I-1, FIG. 4J-1, FIG. 4K-1, FIG. 4L-1 and FIG. 4M-1 show examples of the case where signals equivalent to the signals shown in FIG. 4A-1, FIG. 4B-1, FIG. 4C-1, FIG. 4D-1, FIG. 4E-1, and FG. 4F-1 in the case where AC voltages of shifting the phase of terminals c1, c2, c3 by 120 degrees are applied to the matrix converter 154 as shown in FIG. 3D. In these cases, in the halt period, the matrix converter 154 outputs a voltage ranked as a specific magnitude order among a plurality of input voltages. More specifically, the matrix converter 154 receives the plurality of phase AC voltages, outputs the voltage of the phase ranked as any magnitude order among the plurality of phase AC voltages in the halt period, and performs switching at a time interval longer than the predetermined time interval so that the voltage ranked as a specific magnitude order is output when the magnitude order changes during the halt period.

For example, when the halt is set at the level of 100% in the tables shown in FIGS. 4A-3, 4B-3, 4C-3, 4D-3, 4E-3, FIGS. 4F-3 and 4G-1, the maximum voltage among the three AC voltages applied to the terminals c1, c2, and c3 is output from the matrix converter 154. For example, when the halt is set at the level of 0% in the tables shown in FIGS. 4A-3, 4B-3, 4C-3, 4D-3, 4E-3, 4F-3, and 4G-1, an intermediate voltage among the three AC voltages applied to the terminals c1, c2, and c3 is output from the matrix converter 154. For example, when the halt is set at the level of −100% in the tables shown in FIGS. 4A-3, 4B-3, 4C-3, 4D-3, 4E-3, 4F-3, and 4G-1, the minimum voltage among the three AC voltages applied to the terminals c1, c2, and c3 is output from the matrix converter 154.

### Features and Effects of First Embodiment

In the power converting apparatus 1 according to the first embodiment, during the halt period in which the plurality of switching elements of at least one of the single-phase power converting cells 15 among the plurality of single-phase power converting cells 15 connected in series each other do not perform switching at the short time interval and output an output voltage, the plurality of switching elements of the remaining single-phase power converting cells 15 among the plurality of single-phase power converting cells 15 is configured to perform switching at the short time interval and output an output voltage. Therefore, since the plurality of single-phase power converting cells 15 periodically decrease the switching, it is possible to reduce the switching loss without deteriorating the control response due to the switching.

### Second Embodiment

In the first embodiment, it is shown that the single-phase power converting cell 15 which is a part of one series multiplex power converter 13 enters the halt period, the remaining single-phase power converting cells 15 enter the switching operation (PWM output period). However, when the power converting apparatus 1 includes a plurality of series multiplex power converter 13, all the single-phase power converting cell 15 constituting a part of the series multiplex power converter 13 may enter the halt period and the single-phase power converting cell 15 constituting the remaining series multiplex power converter 13 may enter the switching operation (PWM output period). That is, the controller 20 outputs the drive signal to each of the plurality of single-phase power converting cells 15 so that the plurality of switching elements in the plurality of single-phase power converting cells 15 constituting the remaining series multiplex power converter among the plurality of series multiplex power converter 13 perform switching at the short time interval and output an output voltage during the halt period in which the plurality of switching elements do not perform switching at the short time interval and output an output voltage in each of the plurality of single-phase power converting cells 15 constituting at least of the series multiplex power converter 13 among the plurality of series multiplex power converter 13. Hereinafter, as a typical example, in the phase voltage of U-phase, V-phase, W-phase outputted from the terminals Tu, Tv, and Tw of the circuit shown in FIG. 2C-2, discontinuous PWM in which one of the phase voltages is halted will be described. In the case of the discontinuous PWM, the power converting apparatus 1 includes three series multiplex power converter 13 as the at least one series multiplex power converter 13. The three series multiplex power converter 13 respectively output a first phase voltage, a second phase voltage, and a third phase voltage. The single-phase power converting cell 15 in the case of performing discontinuous PWM is typically a two-level inverter of three phase output.

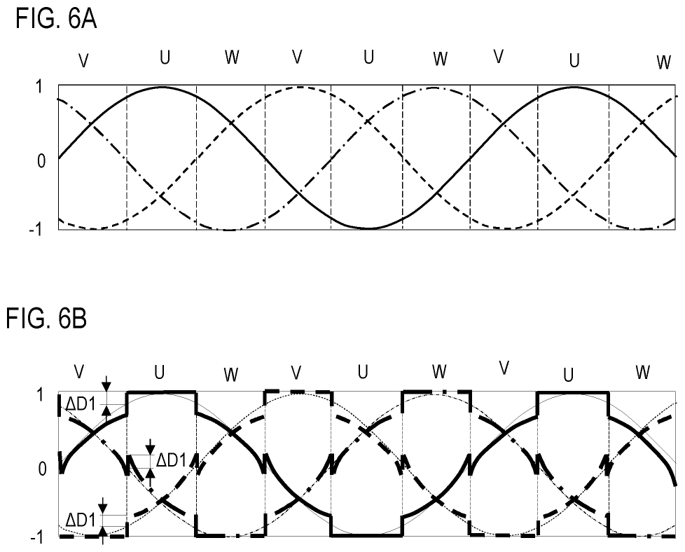

FIG. 6A is a graph showing the voltage command of each phase on which the discontinuous PWM is based. FIG. 6B is a graph illustrating the concept of discontinuous PWM. In FIG. 6B, the original voltage command shown in FIG. 6A is shown by a thin line, and the voltage command after modulation is shown by a thick line. In FIG. 6A, the phase voltage commands of the U-phase, V-phase, and W-phase are indicated by a solid line, a dotted line, and an alternate long and short dash line, respectively. In FIG. 6A, the phase voltage commands of the U-phase, the V-phase, and the W-phase are illustrated as typical sine waves shifted from each other by 120 degrees. In the discontinuous PWM, first, the phase having the largest absolute value is selected from the phase voltage commands of the U-phase, V-phase, and W-phase. This selected phase is referred to as the selected phase. FIG. 6A of the diagram shows the phase with the greatest magnitude above the graph, and when the phases with the greatest magnitude are interchanged, they are indicated by vertical dotted lines. A period during which the selected phase shown between vertical dotted lines is selected is referred to as a selection period. This selection period is a halt period in the selected phase. Then, as shown in FIG. 6B, when the command value of the phase voltage command in the selected phase is positive, the phase voltage command is set to the maximum value that the phase voltage command can take. When the command value of the phase voltage command in the selected phase is negative, the phase voltage command is set to the minimum value that the phase voltage command can take.

Next, in order not to change the line voltage before and after the change, the voltage values of the phases other than the selected phase are shifted by the value ΔD1 by which the selected phase is shifted. For example, FIG. 6 illustrates the shift amount ΔD1 when the selected phase is switched from the W-phase to the U-phase. When the U-phase is halted after the switching and outputs the maximum value Vmax of the phase voltage command, the shift amount ΔD1 is sequentially calculated as ΔD1=Vmax−Vu using the phase voltage command Vu of the U-phase. Then, in the selection period, the voltage values of the phases other than the selected phase are adjusted with reference to the voltage of the selected phase so that the line voltage does not change before and after the discontinuous PWM. For example, when the U-phase is selected as the selected phase, the voltages other than the selected phase are adjusted using the sequentially calculated ΔD1 so that the line voltages Vvu (=Vv−Vu) and Vwv (=Vw−Vv) (where Vu, Vv, and Vw are the voltages of the U-phase, the V-phase, and the W-phase, respectively) are not changed. The voltage thus adjusted is referred to as an adjusted phase voltage command s1. FIG. 1 illustrates a configuration of the command generator 21 for realizing such a function. The command generator 21 includes a phase selector 23 that selects a selected phase from a plurality of phase voltage commands s0 serving as a base. When the selected phase is selected, the command generator 21 generates the adjusted phase voltage command s1 from the phase voltage command s0. That is, the controller 20 deactivates all the single-phase power converting cell 15 of the serial multiplex power converter 13 corresponding to the selected phase. The halt period is determined as a period during which the single-phase power converting cell 15 that outputs the output voltage of the maximum rank or the minimum rank is selected from among the plurality of single-phase power converting cells 15 constituting the series multiplex power converter 13 based on the algorithm of the discontinuous PWM.

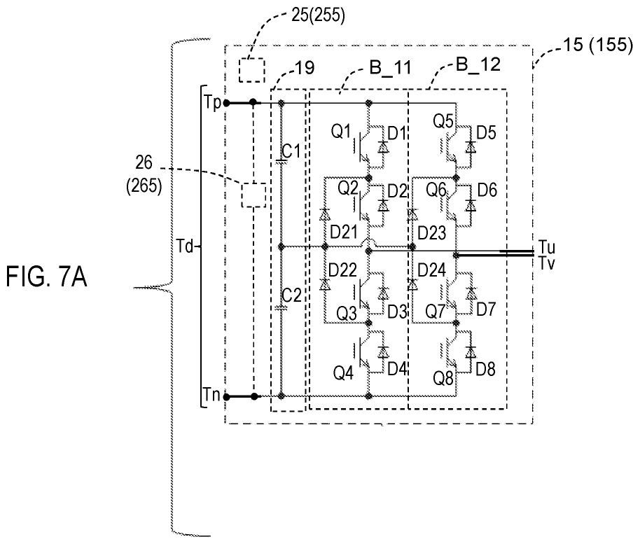

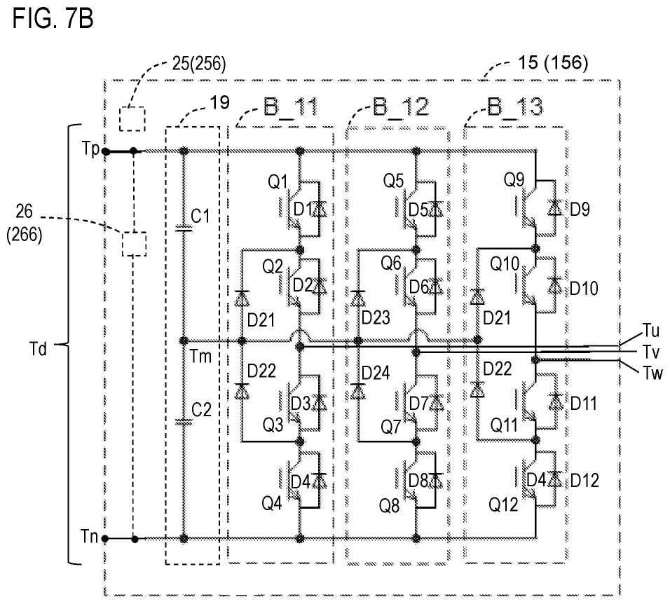

The contents described above are applicable not only to the power converting apparatus 1 including the plurality of series multiplex power converters 13 but also to the power converting apparatus 1 including one single-phase power converting cell 15 having two or more output phases. FIGS. 7A and 7B are schematic diagrams showing still other examples 155 and 156 of single-phase power converting cell 15, respectively. In the drawing FIG. 7A, the single-phase power converting cell 155 are three-level inverters including arms B_11 and B_12 including a plurality of switching elements Q1 to Q8. On the other hand, in FIG. 7B, single-phase power converting cell 155 are three-level inverters including arms B_11 to B_13 including a plurality of switching elements Q1 to Q12. Here, not only the single-phase power converting cell 155 and 156 but also the circuits of FIGS. 2B to 2F are referred to as multilevel converters because these circuits output voltages of a plurality of levels. The three-level inverter 156 can also output the above-described discontinuous PWM.

The multi-level converter further includes the controller 20 shown in FIG. 1. Specifically, the controller 20 includes a command generator 21, a PWM signal generator 22, and a phase selector 23. The command generator 21 generates a phase voltage command s0 corresponding to each of the plurality of phase voltages and an adjusted phase voltage command s1 to be compared with the carrier signal. The PWM signal generator 22 generates the drive signal based on the adjusted phase voltage command s1 and the carrier signal. The phase selector 23 sequentially selects the selected phase among the plurality of phases such that an absolute value of a phase voltage command s0 corresponding to the selected phase is maximum among absolute values of phase voltage commands s0 corresponding to the plurality of phases.

The multilevel converter may employ the following modulation method as a modulation method other than the discontinuous PWM. In the discontinuous PWM, when the command value of the phase voltage command in the selected phase is positive, the phase voltage command is set to the maximum value that the phase voltage command can take. When the command value of the phase voltage command in the selected phase is negative, the phase voltage command is set to the minimum value that the phase voltage command can take. Alternatively, the adjusted phase voltage command may be generated such that the selected phase is at an intermediate level between the maximum value and the minimum value among the three levels. That is, during the halt period (selection period) in which the selected phase is selected, the command generator 21 generates the adjusted phase voltage command such that the phase voltage command corresponding to the selected phase has a value corresponding to an intermediate voltage level among the three voltage levels.

In this modulation method, since the shift amount is larger than that of the discontinuous PWM and the remaining phases shift in a direction away from the central voltage level at the time of shift, if the phase voltage command s0 is expressed between the voltage of the maximum level and the voltage of the minimum level as in the discontinuous PWM, there is a possibility that the remaining phases do not fall between the voltage of the maximum level and the voltage of the minimum level at the time of shift. Therefore, it is necessary that the difference D between the maximum and minimum values of the phase voltage command s0 is smaller than the reference value. Since this modulation method is similar to the discontinuous PWM, the differences from the discontinuous PWM will be mainly described.

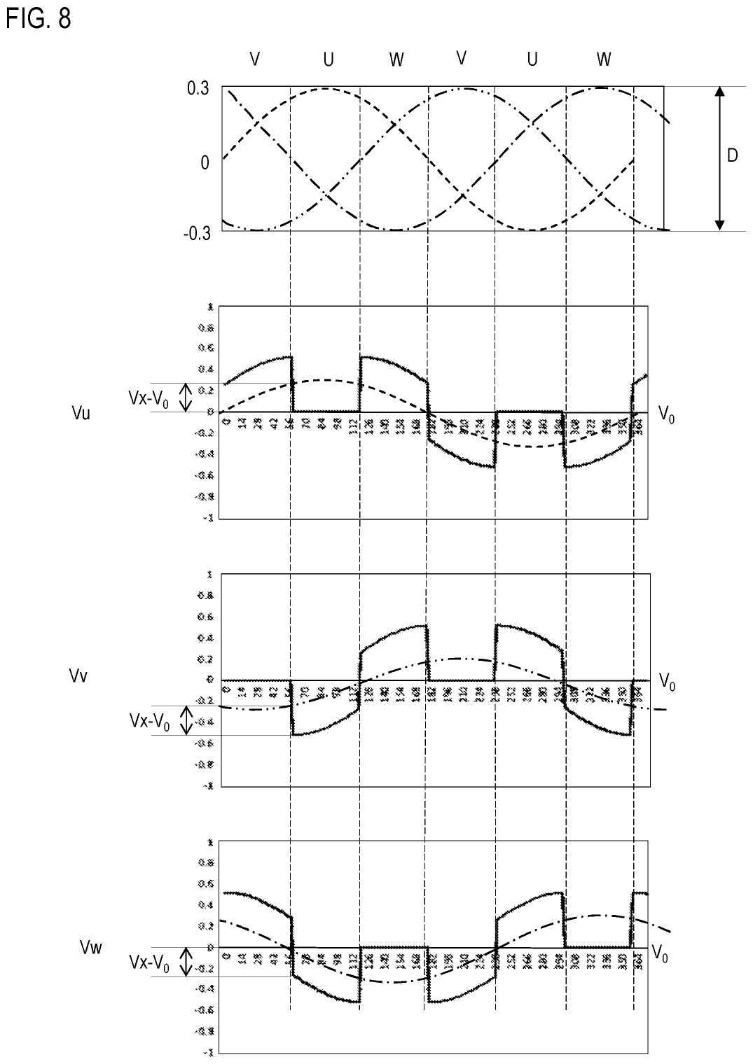

FIG. 8 is an explanatory diagram for explaining a concept of a modulation method for setting the selected phase to a value corresponding to an intermediate voltage level in the second embodiment. In the upper diagram of FIG. 8, the original phase voltage command s0 of the U-phase, the W-phase, and the V-phase is indicated by a dotted line, a two-dot chain line, and a one dot chain line, respectively. Typically, these are represented by sine waves shifted by 120 degrees, but may be represented by other waves. When the difference between the maximum and minimum values of the voltage level of the three-level inverter is 2 (the intermediate level is normally 0), the difference D between the maximum and minimum values of the phase voltage command s0 is 0.6. The selection method of the selected phase is the same as that of the discontinuous PWM. In the upper part of FIG. 8, the name of the selected phase is indicated.

The lower three diagrams of FIG. 8 indicate the voltages Vv, Vw, and Vv of the adjusted phase voltage command s1 of the U-phase, the W-phase, and the V-phase, respectively. For clarifying the explanation, the phase voltage command s0 is also shown in FIG. 3. Referring to these figures, during the halt period (selection period) in which the selected phase is selected, the adjusted phase voltage command s0 is generated such that the phase voltage command Vo corresponding to the selected phase has a value corresponding to the intermediate voltage level s1 of the three voltage levels. When the phase voltage command corresponding to the selected phase is Vx and the adjusted phase voltage command corresponding to the selected phase in the halt period (selection period) is Vo, the adjusted phase voltage command s1 corresponding to the remaining phases other than the selected phase among the plurality of phases is set to a value obtained by subtracting (Vx−Vo) from the phase voltage command corresponding to the remaining phases. By performing such adjustment, the line voltage is maintained.

When this modulation method is used, the PWM signal generator 22 generates the drive signal based on the adjusted phase voltage command s0 and the carrier signal when the difference D between the maximum and minimum values of the phase voltage command s0 is smaller than the threshold value, and generates the drive signal based on the phase voltage command s0 instead of the adjusted phase voltage command s1 when the difference D is equal to or larger than the threshold value.

### Features and Effects of Second Embodiment

In the power converting apparatus according to the second embodiment, in the halt period in which the plurality of switching elements do not perform switching at the short time interval for each of the plurality of single-phase power converting cells 15 constituting at least one of the plurality of series multiplex power converter 13 of the plurality of the series multiplex power converter 13, the plurality of switching elements perform switching at the short time interval and output an output voltage for the plurality of single-phase power converting cells 15 constituting the remaining ones of the plurality of series multiplex power converter 13 of the plurality of the series multiplex power converter 13. Therefore, the switching loss can be reduced without lowering the control response.

### Third Embodiment

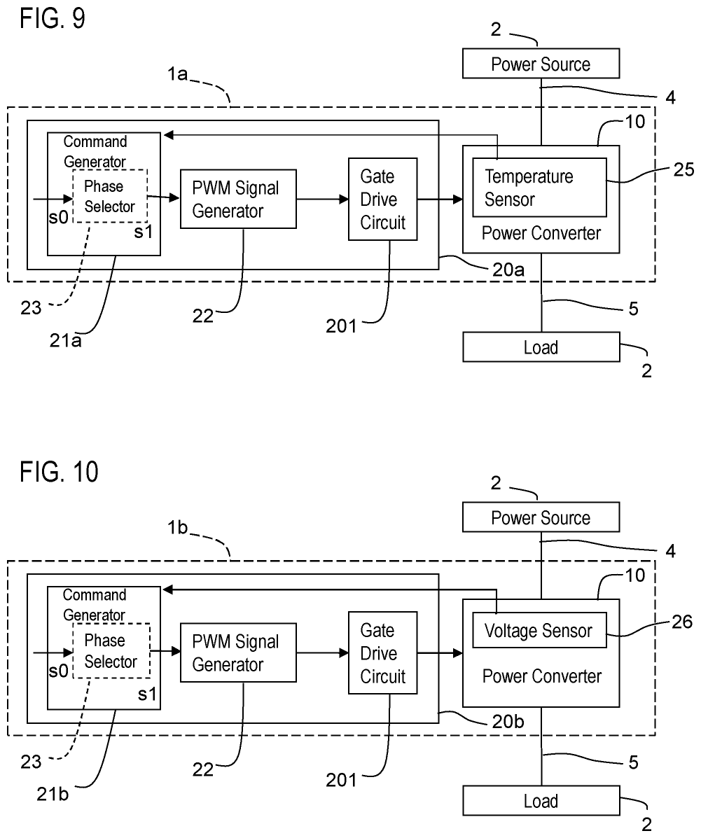

FIG. 9 is a schematic diagram showing an overall configuration of a power converting apparatus 1a according to a third embodiment. As compared with the power converting apparatus 1 of the first and second embodiments, the power converting apparatus 1a further includes a plurality of temperature sensors 25 that respectively detect temperatures of the plurality of single-phase power converting cells 15. The power converting apparatus 1a has a controller 20a, and the controller 20a outputs a drive signal to each of the plurality of single-phase power converting cells 15 when the temperature of a part of single-phase power converting cell 15 among the plurality of single-phase power converting cells 15 is higher than or equal to the threshold temperature of the remaining single-phase power converting cells, so that the total sum of the halt period of the plurality of single-phase power converting cells 15 is longer than the total sum of the each halt period of the remaining plurality of single-phase power converting cells 15 in a unit time obtained by multiplying the time of one cycle of the phase voltage by the number of the plurality of single-phase power converting cells 15 in one series multiplex power converter 13.

To be specific, as shown in FIS. 3A, 3D, 7A, and 7B, each of the single-phase power converting cell 150 (151 to 156) includes the temperature sensors 25 (251 to 256) that detect the temperatures of the respective single-phase power converting cell 150 (151 to 156). The command generator 21 receives the temperature of each single-phase power converting cell 150 (151 to 156), and adjusts the voltage command so as to lengthen the halt period for the single-phase power converting cell whose temperature is higher than or equal to the threshold temperature. For example, in the examples of FIGS. 4C-3 and 4D-3, when the temperature of the unit converter A_11 is lower than the threshold temperature and the temperature of the unit converter A_12 is equal to or higher than the threshold temperature, the frequency can be reduced until the temperature decreases, for example, driving in odd cycles is performed three times out of four times and driving in even cycles is performed one time out of four times. In the examples of FIGS. 4E-3 and 4F-3, for example, when the temperature of the unit converter A_11 is equal to or higher than the threshold temperature, and the temperature of the unit converters A_12 and A_13 is less than the threshold temperature, the number of times of STAGE 1 may be reduced and STAGE 2 and STAGE 3 may be increased instead of equally applying STAGE 1, 2, and 3. In the example of FIG. 4G-1, for example, when the temperature of the unit converter A_11 is equal to or higher than the threshold-value temperature and the temperatures of the unit converters A_12, A_13, and A_14 are lower than the threshold-value temperature, the number of times of STAGE 1 may be decreased and the number of times of STAGE 2 to STAGE 4 may be increased instead of equally applying STAGE 1 to STAGE 4.

### Features and Effects of Third Embodiment

In the power converting apparatus 1a according to the third embodiment, the total sum of the halt period in which switching is not performed can be increased in the single-phase power converting cell 15 having a high temperature due to a large value of the input bus voltage among the plurality of single-phase power converting cells 15. Therefore, heat generation of the entire power converting apparatus 1a can be reduced, and durability of the power converting apparatus 1a can be improved.

### Fourth Embodiment

FIG. 10 is a schematic diagram showing an overall configuration of a power converting apparatus 1b according to a fourth embodiment. As compared with the power converting apparatus 1 of the first and second embodiments, the power converting apparatus 1b further includes a plurality of voltage sensors 26 that respectively detect the bus voltages input to the plurality of single-phase power converting cells 15. The power converting apparatus 1b has a controller 20b, and the controller 20b outputs a drive signal to each of the plurality of single-phase power converting cells 15 so that the total sum of the halt periods of each of a part of single-phase power converting cells 15 is longer than the total sum of the halt periods of each of remaining plurality of single-phase power converting cells 15 in a unit time obtained by multiplying one cycle time of the phase voltage by the number of the plurality of single-phase power converting cells 15 in one series multiplex power converter 13 when the bus voltage of the plurality of single-phase power converting cells 15 is higher than the bus voltage of the remaining single-phase power converting cells 15.

To be more specific, as shown in FIGS. 3A, 3D, 7A, and 7B, each of the single-phase power converting cell 150 (151 to 156) includes a voltage sensor 26 (261, 262, 263a, 263b, 264a, 264b, 265, 266) that detects the bus voltage of each of the single-phase power converting cell 150 (151 to 156). The command generator 21 receives the bus voltage of each of the single-phase power converting cell 150 (151 to 156), and adjusts the voltage command so as to lengthen the halt period when the bus voltage is higher than or equal to the threshold voltage. With regard to the single-phase power converting cells 153 and 154 having two voltage sensors 26, when the bus voltage of any one of the voltage sensors 26 (263a, 263b), (264a, 264b) is equal to or higher than the threshold voltage, the drive signal is output to each of the plurality of single-phase power converting cells 153 so as to be longer than the sum of the halt period of the remaining single-phase power converting cells 153.

For example, in the examples of FIGS. 4C-3 and 4D-3, when the bus voltage of the unit converter A_11 is lower than the threshold voltage and the bus voltage of the unit converter A_12 is equal to or higher than the threshold voltage, the frequency can be reduced such that the odd-numbered driving is performed three times out of four times and the even-numbered driving is performed one time out of four times until the bus voltage decreases. In the examples of FIGS. 4E-3 and 4F-3, for example, when the bus voltage of the unit converter A_11 is equal to or higher than the threshold voltage and the bus voltages of the unit converters A_12 and A_13 are lower than the threshold voltage, the number of STAGE 1 may be decreased and the number of STAGE 2 and STAGE 3 may be increased instead of applying STAGE 1, 2, 3 equally. In the example of FIG. 4G-1, for example, when the bus voltage of the unit converters A_11 is equal to or higher than the threshold voltage and the bus voltages of the unit converters A_12, A_13, and A_14 are lower than the threshold voltage, the number of times of STAGE 1 may be reduced and the number of times of STAGE 2 to STAGE 4 may be increased instead of uniformly applying STAGE 1 to STAGE 4.

### Features and Effects of Fourth Embodiment

In the single-phase power converting cell 15 in which the bus voltage is high among the plurality of single-phase power converting cells 15, the total sum of the halt period in which switching is not performed can be increased. Since the loss due to switching is large when the bus voltage is high, it is possible to reduce the power loss of the entire power converting apparatus 1c by increasing the total sum of the halt period in which switching is not performed.

### Modification

It should be noted that the exemplary embodiments disclosed and described herein illustrate preferred embodiments of the present invention and are not intended to limit the scope of the claims herein in any way. Many modifications and variations of the present invention are possible in light of the above teachings. It is therefore to be understood that within the scope of the appended claims, the invention may be practiced otherwise than as specifically described herein.

In the power converting apparatus according to the embodiment and the control method of the power converting apparatus according to the embodiment, during a halt period in which the plurality of switching elements of at least one of the plurality of single-phase power converting cells among the plurality of single-phase power converting cells connected in series with each other do not perform switching at the short time interval, the plurality of switching elements of the remaining single-phase power converting cells among the plurality of single-phase power converting cells perform switching at the short time interval and output an output voltage. Therefore, since the plurality of single-phase power converting cells periodically decrease the switching, it is possible to reduce the switching loss without deteriorating the control response.

In the power converting apparatus according to the embodiment and the control method of the power converting apparatus according to the embodiment, in the halt period in which the plurality of switching elements do not perform switching and output an output voltage at the short time interval for each of the plurality of single-phase power converting cells constituting at least one of the plurality of series multiplex power converters, the plurality of switching elements perform switching at the short time interval for the plurality of single-phase power converting cells constituting the remaining one of the plurality of series multiplex power converters among the plurality of series multiplex power converters. Therefore, since each of the plurality of series multiplex power converters periodically decreases switching, switching loss can be reduced without lowering control response.

In the power converting apparatus according to the embodiment, since switching is performed for each voltage range, it is easy to determine the switching elements to be driven based on the voltage command. In addition, when the voltage ranges are equal to each other, it is easy to distribute a load related to switching.

In the power converting apparatus according to the embodiment, since the number of the voltage ranges in which switching is not performed can be made equal in the plurality of single-phase power converting cells, the load on each of the plurality of single-phase power converting cells can be substantially equally distributed.

In the power converting apparatus according to the embodiment, in the plurality of single-phase power converting cells, the total sum of the halt period in which switching is not performed can be made substantially equal to each other. Therefore, the load on each of the plurality of single-phase power converting cells can be distributed substantially equally.

In the power converting apparatus according to the embodiment, in the single-phase power converting cells having a high temperature among the plurality of single-phase power converting cells, the total sum of the halt period in which switching is not performed can be increased. Therefore, it is possible to suppress the temperature rise of the single-phase power converting cells and improve the durability of the power converting apparatus.

In the power converting apparatus according to the embodiment, in the single-phase power converting cells having the higher bus voltage among the plurality of single-phase power converting cells, it is possible to increase the total sum of the halt period in which switching is not performed. When the bus voltage is high, the loss due to switching is large. Therefore, by increasing the total sum of the halt period in which switching is not performed, it is possible to suppress the temperature rise of the single-phase power converting cell 15 and improve the durability of the power converting apparatus.

In the power converting apparatus according to the embodiment, since the serial multiplex power converter can be stopped using an algorithm of discontinuous PWM, the power loss of the entire power converting apparatus can be reduced while stably controlling the load.

In the power converting apparatus according to the embodiment, a matrix converter can be used as the single-phase power converting cell.

In the power converting apparatus according to the embodiment, the control according to the first aspect to the ninth aspect can be performed even when the AC power source is used.

In the power converting apparatus according to the embodiment, when the PWM signal is output using the carrier signal, it is possible to reduce the loss of the power converting apparatus.

In the three-level inverter according to the embodiment and the control method of the three-level inverter according to the embodiment, since the voltage at the intermediate level is output in the halt period, the power consumption can be reduced.

In the three-level inverter according to the embodiment, since it is possible not to change the line voltage even if the halt period is provided, it is possible to reduce the power loss of the three-level inverter while appropriately controlling the load.

In the three-level inverter according to the embodiment, since the halt period is not provided when the difference between the maximum value and the minimum value of the phase voltage commands is larger than the threshold value, it is possible to reduce the power loss of the three-level inverter while maintaining the maximum output voltage even if there is the shift of the thirteenth aspect.

In the control method of the power converting apparatus according to the embodiment, when the PWM signal is output using the carrier signal, the loss of the power converting apparatus can be reduced.

The techniques disclosed herein allow for the use of higher carrier frequencies without degrading control response to undesirable levels. The technique can also advantageously reduce harmonic voltages.

As used herein, the term “comprising” and its derivatives are open-ended terms that specify the presence of elements but do not preclude the presence of other non-recited elements. This also applies to the terms “comprising”, “including” and their derivatives.

The terms “member”, “component”, “element”, and “structure” may have multiple meanings, such as a single part or multiple parts.

Ordinal numbers such as “first” and “second” are merely terms for identifying configurations and do not have any other meaning (e.g., a particular order). For example, “a first element” does not imply that “a second element” is present, and “a second element” does not imply that “a first element” is present.

Terms of degree such as “substantially,” “about,” and “approximately,” unless specifically stated in an embodiment, can mean a reasonable amount of deviation such that the end result is not significantly changed. All numerical values set forth in this application can be interpreted to include words such as “substantially,” “about,” and “approximately.”

In this application, the phrase “at least one of A and B” should be interpreted to include A alone, B alone, and both A and B.

Obviously, numerous modifications and variations of the present invention are possible in light of the above teachings. Accordingly, the present invention may be practiced otherwise than as specifically disclosed herein without departing from the scope of the present invention.

What is claimed is:

1. A power converting apparatus comprising:
one or more series multiplex power converter each including a plurality of single-phase power converting cells, outputs of the plurality of single-phase power converting cells being connected to each other in series;
control circuitry configured to output a drive signal;
each of the plurality of single-phase power converting cells having a plurality of switching elements and configured to output an output voltage by switching the plurality of switching elements in accordance with the drive signal; and
the control circuitry being configured to output the drive signal respectively to the plurality of single-phase power converting cells such that, during a halt period in which the plurality of switching elements of at least one of the plurality of single-phase power converting cells do not perform switching at a short time interval which is shorter than a predetermined time interval to output the output voltages, the plurality of switching elements of a remainder of the plurality of single-phase power converting cells performs switching at the short time interval to output the output voltages.

2. The power converting apparatus according to claim 1,
wherein the one or more series multiplex power converter comprises a plurality of series multiplex power converters, and
wherein the control circuitry is configured to output the drive signal respectively to the plurality of single-phase power converting cells such that, during a halt period in which the plurality of switching elements of each of a plurality of single-phase power converting cells that constitute at least one of the plurality of series multiplex power converters do not perform switching at the short time interval to output the output voltages, the plurality of switching elements of a remainder of the plurality of series multiplex power converters performs switching at the short time interval to output the output voltages.

3. The power converting apparatus according to claim 2,
wherein each of the at least one of the plurality of series multiplex power converters outputs a phase voltage,
wherein (a number of a plurality of single-phase power converting cells in one series multiplex power converter)×(a number of levels of the plurality of single-phase power converting cells−1)×2 is N, and
wherein the control circuitry sets a voltage range by dividing a range between a maximum output voltage and a minimum output voltage in one cycle of the phase voltage by a divisor of N, determines the halt period by a time during which the phase voltage continuously exists in one voltage range or a plurality of continuous voltage ranges for each cycle, and outputs the drive signal respectively to the plurality of single-phase power converting cells.

4. The power converting apparatus according to claim 3,
wherein the control circuitry outputs the drive signal to each of the plurality of single-phase power converting cells so that the plurality of single-phase power converting cells have equal number of the voltage ranges in which the plurality of switching elements do not perform the switching at the short time interval in a unit time obtained by multiplying a time of the one cycle by the number of the plurality of single-phase power converting cells in the one series multiplex power converter.

5. The power converting apparatus according to claim 4,
wherein the control circuitry outputs the drive signal to each of the plurality of single-phase power converting cells such that a total sum of halt periods of each of the plurality of single-phase power converting cells in the unit time is substantially equal.

6. The power converting apparatus according to claim 3, further comprising:
a plurality of temperature sensors configured to detect temperatures of the plurality of single-phase power converting cells, respectively,
wherein, when a temperature of a part of the plurality of single-phase power converting cells is higher than temperatures of a remainder of the plurality of single-phase power converting cells by a threshold temperature or more, the control circuitry outputs the drive signal to each of the plurality of single-phase power converting cells such that a total sum of halt periods of the part of the plurality of single-phase power converting cells is longer than a total sum of the halt periods of the remainder of the plurality of single-phase power converting cells in a unit time obtained by multiplying a time of the one cycle by the number of the plurality of single-phase power converting cells in the one series multiplex power converter.

7. The power converting apparatus according to claim 3, further comprising:
a plurality of voltage sensors to detect bus voltages of the plurality of single-phase power converting cells respectively,
wherein, when a bus voltage of a part of the plurality of single-phase power converting cells is higher than bus voltages of a remainder of the plurality of single-phase power converting cells by a threshold voltage or more, the control circuitry outputs the drive signal to each of the plurality of single-phase power converting cells so that a total sum of the halt periods of the part of the single-phase power converting cells is longer than a total sum of the halt periods of the remainder of the plurality of single-phase power converting cells in a unit time obtained by multiplying a time of the one cycle by a number of the plurality of single-phase power converting cells in the one series multiplex power converter.

8. The power converting apparatus according to claim 2,
wherein the one or more series multiplex power converter comprises three series multiplex power converters,
wherein the three series multiplex power converters output a first phase voltage, a second phase voltage, and a third phase voltage, respectively, and
wherein the halt period is determined, based on an algorism of discontinuous PWM, as a period during which one of the first phase voltage, the second phase voltage, and the third phase voltage becomes a maximum level or a minimum level.

9. The power converting apparatus according to claim 2,
wherein the power converting apparatus is a matrix converter, and
wherein, in the halt period, the matrix converter outputs a voltage ranked as a specific magnitude order among a plurality of input voltages.

10. The power converting apparatus according to claim 9,
wherein the matrix converter receives a plurality of phase AC voltages as inputs, outputs a voltage of a phase ranked as any magnitude order among the plurality of phase AC voltages in the halt period, and performs switching at a time interval longer than the predetermined time interval in order for the voltage ranked as the specific magnitude order to be output when the magnitude order changes during the halt period.

11. The power converting apparatus according to claim 10,
wherein one cycle of each of the plurality of phase AC voltages is longer than the predetermined time interval.

12. The power converting apparatus according to claim 1,
wherein the predetermined time interval is one cycle of a carrier signal that is compared with a voltage command to generate the drive signal.

13. A three-level inverter comprising:
a plurality of switching elements;
control circuitry configured to output drive signals; and
a DC power source configured to output three voltage levels;
the plurality of switching elements being connected to the DC power source and configured to output a plurality of phase voltages corresponding to a plurality of phases by switching the switching elements; and
the control circuitry comprising:
a command generator configured to generate phase voltage commands corresponding to the plurality of phase voltages respectively and adjusted phase voltage commands to be compared with carrier signals;
a PWM signal generator configured to generate the drive signals based on the adjusted phase voltage commands and the carrier signals; and
a phase selector configured to sequentially select a selected phase among the plurality of phases such that an absolute value of a phase voltage command corresponding to the selected phase is maximum among absolute values of phase voltage commands corresponding to the plurality of phases, respectively,
wherein the command generator sets a period during which the selected phase is selected as a halt period and generates the adjusted phase voltage commands such that the phase voltage command corresponding to the selected phase is set to a value corresponding to an intermediate voltage level among the three voltage levels.

14. The three-level inverter according to claim 13,
wherein a phase voltage command corresponding to the selected phase is set to Vx,
wherein the adjusted phase voltage command corresponding to the selected phase in the halt period is Vo, and
wherein the adjusted phase voltage commands corresponding to the remaining phases other than the selected phase among the plurality of phases are set to a value obtained by subtracting (Vx−Vo) from the phase voltage commands corresponding to the remaining phases.

15. The three-level inverter according to claim 13,
wherein, when the difference between the maximum value and the minimum value of the phase voltage commands is smaller than the threshold value, the PWM signal generator generates the drive signals based on the adjusted phase voltage commands and the carrier signals, and
wherein, when the difference is equal to or greater than the threshold value, the PWM signal generator generates the drive signals based on the phase voltage commands instead of the adjusted phase voltage commands.

16. A control method of a power converting apparatus, comprising:
providing one or more series multiplex power converters each having a plurality of single-phase power converting cells, each of the plurality of single-phase power converting cells having a plurality of switching elements, outputs of the plurality of single-phase power converting cells being connected to each other in series;
outputting drive signals in a halt period to a plurality of the switching elements of at least one of the plurality of single-phase power converting cells such that the plurality of the switching elements of the at least one of the plurality of single-phase power converting cells do not perform switching at a short time interval shorter than a predetermined time interval to output the output voltages; and
outputting the drive signals in the halt period to a plurality of the switching elements of a remainder of the plurality of single-phase power converting cells such that the plurality of switching elements of the remainder of the plurality of single-phase power converting cells perform the switching at the short time interval to output the output voltages.

17. The control method of the power converting apparatus according to claim 16, further comprising:
providing plurality of series multiplex power converters as the one or more series multiplex power converter;
outputting drive signals in the halt period to a plurality of single-phase power converting cells constituting at least one of the plurality of the series multiplex power converters such that the plurality of switching elements of the plurality of single-phase power converting cells constituting the at least one of the series multiplex power converter do not perform switching at the short time interval to output the output voltages; and
outputting drive signals to a plurality of single-phase power converting cells constituting a remainder of the plurality of the series multiplex power converters such that the plurality of switching elements of the plurality of single-phase power converting cells constituting the remainder of the plurality of the series multiplex power converters perform the switching at the short time interval to output the output voltages.

18. A control method of a three-level inverter, comprising:
providing the three-level inverter including a DC power source to output three voltage levels, a plurality of switching elements connected to the DC power source, and control circuitry to output drive signals;
switching driving of each of the plurality of switching elements to output a plurality of phase voltages corresponding to a plurality of phases;
generating phase voltage commands corresponding to each of the plurality of phase voltages and adjusted phase voltage commands to be compared with carrier signals;
generating the drive signals based on the adjusted phase voltage commands and the carrier signals;
sequentially selecting a selected phase among the plurality of phases such that an absolute value of a phase voltage command corresponding to the selected phase is maximum among absolute values of phase voltage commands corresponding to the plurality of phases, respectively; and
generating the adjusted phase voltage commands during a halt period in which the selected phase is selected such that the phase voltage command corresponding to the selected phase is set to a value corresponding to an intermediate voltage level among the three voltage levels.

19. The control method of the power converting apparatus according to claim 16,
wherein the predetermined time interval is one cycle of a carrier signal that is compared with a voltage command to generate the drive signal.
